(19) United States
(12) Patent Application Publication
(10) Pub. No.: US 2026/0359672 A1
(43) Pub. Date: Nov. 12, 2026

(54) INFERENCE ENGINE USING DIRECTED PROPERTY GRAPHS

(71) Applicant: Infosys Limited, Bangalore (IN)

(72) Inventors: Steven SCHILDERS, Indianapolis, IN (US); Chitra THEAGARAJAN, Bengaluru (IN)

(73) Assignee: Infosys Limited, Bangalore (IN)

(21) Appl. No.: 19/081,650

(22) Filed: Mar. 17, 2025

(51) Int. Cl. G06N 5/04; G06F 16/901

(52) U.S. Cl. CPC G06N 5/04; G06F 16/9024

(57) ABSTRACT

A system for an inference engine using directed property graphs is provided. An inference graph is generated based on a stimulus. To generate the inference graph, a data instance node, various property instance nodes associated with the data instance node, and property value nodes associated with the property instance nodes are generated. Based on a template graph, property template nodes corresponding to the property instance nodes are identified. Further, based on a rule graph, for each property template node, atomic rule nodes associated therewith are identified. The atomic rule nodes are thus associated with each property instance node. Further, an operation associated with the stimulus is executed based on the property instance nodes, the property value nodes, and the atomic rule nodes associated with each property instance node.

### FIELD OF THE DISCLOSURE

Various embodiments of the present disclosure relate generally to directed property graphs. More specifically, various embodiments of the present disclosure relate to an inference engine using directed property graphs.

### BACKGROUND

Real-time tasks such as disease diagnosis, stock trading, approving or rejecting loans in the banking system, or the like, may require quick and efficient decision-making. The decision-making may involve logical analysis of various facts. Rule-based systems, for example, expert systems, may be utilized for executing such logical reasoning operations and making corresponding decisions. In some cases, such rule-based systems may even infer new facts. The logical reasoning operations are typically implemented by way of various rules. The rules and facts may be stored at various databases (such as a relational database, a non-relational database, or the like). The stored facts and rules can be utilized for various use cases such as real-time analytics, fraud detection, alerts, or the like, by way of query processing.

Efficient retrieval of the facts and the rules from the database may play an important role in decision-making. Therefore, the structure of the data storage may directly influence the decision-making. That is to say, suboptimal data storage structure can lead to significant inefficiencies, such as increased query latency, higher computational costs, higher storage requirements, or the like. Such delays or inefficiencies can hinder time-sensitive tasks and may negatively affect the overall performance. Ultimately, these drawbacks may further degrade the user experience and may increase maintenance overhead.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating an inference engine using directed property graphs are provided substantially as shown in, and described in connection with, at least one of the figures.

In an embodiment of the present disclosure, a system is disclosed. The system includes storage circuitry and processing circuitry coupled to the storage circuitry. The storage circuitry is configured to store a template graph and a rule graph. The template graph comprises a plurality of data template nodes and a plurality of property template nodes. The rule graph comprises a plurality of atomic rule nodes. Each data template node is associated with one or more property template nodes, and a property template node is associated with a set of atomic rule nodes. The processing circuitry is configured to receive a stimulus. The processing circuitry is further configured to generate, based on the stimulus, a data instance node, a set of property instance nodes associated with the data instance node, and a set of property value nodes associated with the set of property instance nodes. Further, the processing circuitry is configured to identify, based on the template graph and the data instance node, a set of property template nodes corresponding to the set of property instance nodes. The processing circuitry is further configured to identify, using the rule graph, for each of the set of property template nodes, the set of atomic rule nodes associated therewith. Further, the processing circuitry is configured to execute an operation associated with the stimulus based on at least one of a group consisting of the set of property instance nodes, the set of property value nodes, and the set of atomic rule nodes identified for each of the set of property template nodes.

In some embodiments, each data template node, of the plurality of data template nodes, represents an entity. The one or more property template nodes, associated with each data template node, represent one or more properties associated with the entity, respectively, with a property having a set of property values. The set of atomic rule nodes, associated with the property template node, represents a set of atomic rules to be executed on the set of property values of the property represented by the corresponding property template node.

In some embodiments, the processing circuitry is further configured to identify, using the template graph, a data template node corresponding to the data instance node. The processing circuitry identifies the set of property template nodes from the one or more property template nodes associated with the identified data template node.

In some embodiments, each data template node, of the plurality of data template nodes, has an identifier associated therewith. The data instance node has a template identifier associated therewith. The processing circuitry identifies, from the plurality of data template nodes, the data template node corresponding to the data instance node based on the identifier of the data template node matching the template identifier of the data instance node.

In some embodiments, the processing circuitry identifies the set of property template nodes from the one or more property template nodes based on the set of property value nodes.

In some embodiments, the template graph further comprises a plurality of property value nodes. The property template node, of the one or more property template nodes, is further associated with one or more property value nodes, of the plurality of property value nodes. Further, each of the identified set of property template nodes has at least one property value node that matches one of the set of property value nodes generated based on the stimulus.

In some embodiments, the one or more property value nodes, associated with the property template node, represent one or more property values of a property represented by the corresponding property template node.

In some embodiments, the set of atomic rule nodes represents a set of atomic rules, the data instance node represents an entity, the set of property instance nodes represents a set of properties of the entity, and the set of property value nodes represents a set of property values of the set of properties. To execute the operation, the processing circuitry is further configured to execute, for each property instance node of the set of property instance nodes, the set of atomic rules represented by the corresponding set of atomic rule nodes on a property value represented by the corresponding property value node.

In some embodiments, the processing circuitry is further configured to associate the set of atomic rule nodes identified for each property template node, of the set of property template nodes, with the corresponding property instance node, of the set of property instance nodes.

In some embodiments, the processing circuitry is further configured to generate a set of atomic rule outcomes for the execution of the set of atomic rules associated with each property instance node of the set of property instance nodes, where an atomic rule outcome of the set of atomic rule outcomes corresponds to true or false.

In some embodiments, the processing circuitry is further configured to generate a set of atomic rule outcome nodes for the set of atomic rule outcomes generated for each property instance node of the set of property instance nodes, and associate the set of atomic rule outcome nodes with the corresponding property instance node. The data instance node, the set of property instance nodes, the set of property value nodes, an association of each property instance node with the corresponding set of atomic rule nodes, the set of atomic rule outcome nodes for each property instance node, and the association of each property instance node with the corresponding set of atomic rule outcome nodes constitute an inference graph.

In some embodiments, the processing circuitry is further configured to store the inference graph in the storage circuitry.

In some embodiments, the processing circuitry is further configured to receive a probe and generate a response to the probe based on the inference graph.

In some embodiments, the probe corresponds to at least one of a group consisting of (i) a manual probe or (ii) an automated probe generated based on a system change event.

In some embodiments, the inference graph corresponds to a directed property graph.

In some embodiments, the rule graph further comprises a plurality of composite rule nodes. Further, based on the set of atomic rule outcomes generated for each property instance node of the set of property instance nodes, the processing circuitry is further configured to identify, using the rule graph, one or more composite rule nodes. Each composite rule node, of the one or more composite rule nodes, is dependent on two or more executed atomic rule nodes, each having an atomic rule outcome that is true. The operation associated with the stimulus is further executed based on the one or more composite rule nodes.

In some embodiments, the processing circuitry is further configured to associate each of the one or more composite rule nodes with the corresponding two or more executed atomic rule nodes.

In some embodiments, the one or more composite rule nodes represent one or more composite rules, respectively. To execute the operation, the processing circuitry is further configured to execute the one or more composite rules based on two or more atomic rule outcomes of the dependent two or more executed atomic rule nodes, respectively.

In some embodiments, based on an execution of one or more composite rules, represented by the one or more composite rule nodes, respectively, the processing circuitry is further configured to identify, using the rule graph, at least one other composite rule node that is dependent on at least one of a group consisting of (i) one or more executed atomic rule nodes, each having an atomic rule outcome that is true, or (ii) one or more executed composite rule nodes, each having a composite rule outcome that is true. The operation associated with the stimulus is further executed based on the at least one other composite rule node.

In some embodiments, based on an execution of one or more composite rules, represented by the one or more composite rule nodes, the processing circuitry is further configured to generate one or more composite rule outcomes, respectively. The processing circuitry is further configured to generate one or more composite rule outcome nodes for the one or more composite rule outcomes, respectively.

In some embodiments, an association of the one or more composite rule nodes with the two or more executed atomic rule nodes, and the one or more composite rule outcome nodes generated for the one or more composite rule outcomes, respectively, constitute an inference graph.

In some embodiments, a composite rule outcome of the one or more composite rule outcomes corresponds to another property value associated with the data instance node.

In some embodiments, each of the template graph and the rule graph corresponds to a directed property graph.

In some embodiments, a method is disclosed. The method comprises, receiving, by processing circuitry of a system, a stimulus. A template graph and a rule graph are stored in storage circuitry of the system. The template graph comprises a plurality of data template nodes and a plurality of property template nodes, and the rule graph comprises a plurality of atomic rule nodes, where each data template node is associated with one or more property template nodes, and a property template node is associated with a set of atomic rule nodes. The method further comprises, generating, by the processing circuitry, based on the stimulus, (i) a data instance node, (ii) a set of property instance nodes associated with the data instance node, and (iii) a set of property value nodes associated with the set of property instance nodes. The method further comprises, identifying, by the processing circuitry, based on the template graph and the data instance node, a set of property template nodes corresponding to the set of property instance nodes. The method further comprises, identifying, by the processing circuitry, using the rule graph, for each of the set of property template nodes, the set of atomic rule nodes associated therewith. The method further comprises, executing, an operation associated with the stimulus based on at least one of a group consisting of (i) the set of property instance nodes, (ii) the set of property value nodes, and (iii) the set of atomic rule nodes identified for each of the set of property template nodes.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a block diagram that illustrates a system environment for an inference engine using directed property graphs, consistent with disclosed embodiments of the present disclosure;

FIG. 2A is a schematic diagram that illustrates an association between a template graph and a rule graph, consistent with disclosed embodiments of the present disclosure;

FIG. 2B is a schematic diagram that illustrates generation and utilization of an inference graph by utilizing the template graph and the rule graph, consistent with disclosed embodiments of the present disclosure;

FIGS. 3A and 3B are schematic diagrams that, collectively, represent an example template graph, consistent with disclosed embodiments of the present disclosure;

FIG. 4 is a schematic diagram that represents an example inference graph, consistent with disclosed embodiments of the present disclosure;

FIG. 5 illustrates an example computing system for carrying out the methods of the present disclosure, consistent with disclosed embodiments of the present disclosure; and

FIGS. 6A and 6B, collectively, represent a flowchart that illustrates a method for facilitating inference engine using directed property graphs, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

In decision-centric sectors, such as healthcare, electronic commerce, finance, banking, or the like, making accurate, timely, and informed decisions is of utmost priority. An inference engine is a core component in these sectors that can make an informed decision. A decision may be made based on an analysis of available data. The data may be available in various formats such as datasets, real-time streams, or the like. The data may include various properties (e.g., features) that may describe the data. The inference engine may apply various rules to analyze these properties and make decisions thereupon. For example, a loan approval or rejection dataset may comprise properties like age, income, credit score, employment status, loan amount, or the like. Each of these properties may have multiple possible values. For example, possible values of credit score may include: ‘700’, ‘450’, or the like. Possible values of employment status may include: ‘employed’, ‘unemployed’, or the like. Possible values of loan amount may include: ‘10,000’, ‘30,000’, or the like. The multiple possible values introduce variability in decision-making. For example, the inference engine may apply a rule stating: “IF credit score >600 AND income >30,000, THEN approve the loan”. Therefore, based on the data, the properties of the data, and the predefined rules, the inference engine may make accurate and efficient decisions.

Conventionally, the data as well as the rules may be stored in relational databases. However, managing the relationship between the data and the rules in the relational databases may be cumbersome. For a decision to be made efficiently, the retrieval of both data and rules may play a significant role. Therefore, the structure of the data storage and the rule storage may directly influence the decision-making. That is to say, suboptimal data storage and the rule storage structure can lead to significant inefficiencies, such as increased decision-making latency, higher computational costs, higher storage requirements, or the like.

Notably, real-time availability of data and rules is crucial for efficient decision-making. Delayed retrieval of the data and the rules from the database may be fatal in sectors that demand quick response, such as monitoring stock prices, disease diagnosis, or the like. That is to say, efficient retrieval of data and rules is paramount for minimizing risks in real-time tasks. Additionally, decision-making may involve the analysis of highly interconnected data. The relational databases may not provide flexibility for such analysis. Therefore, the conventional approach of storing the data and the rules in the relational databases may prove to be inadequate in fulfilling the current requirement of fast and efficient decision-making.

The present disclosure provides a different approach to facilitate optimized query processing for efficient decision-making. The present disclosure discloses a template graph and a rule graph that may be based on various data and rules, respectively. Both the template graph and the rule graph may correspond to directed property graphs. The template graph may be derived from a dataset including multiple entities, their associated properties, and corresponding property values. Each property may be associated with one or more property values. The template graph may store entities as data template nodes, with each data template node having an associated identifier. The properties associated with each data template node may be represented as property template nodes. The property values associated with each property may be represented as property value nodes. Further, the rule graph may be derived from a repository of rules. The rules may correspond to atomic rules and composite rules. The composite rule may be dependent on two or more atomic rules and/or other composite rules for execution thereof. Each rule may be represented as a rule node. Further, based on a stimulus, an inference graph may be generated. The stimulus may correspond to a decision-making operation for an entity.

To generate the inference graph, a data instance node, representing the entity, may be generated. The data instance node may have an associated instance identifier and an associated template identifier. Further, property instance nodes may be generated for properties associated with the entity. To represent property values of the properties, property value nodes may be generated. Further, using the template graph, a data template node corresponding to the data instance node may be identified. The identified data template node may have the same identifier as the template identifier of the generated data instance node. Upon the identification of the data template node, property template nodes associated with the data template node may be identified based on the generated property value nodes.

Further, atomic rule nodes associated with each property template node may be identified, using the rule graph. The identified atomic rule nodes are then associated with the generated property instance nodes. For each property instance node, the atomic rules represented by the atomic rule nodes may be executed on the property value represented by the corresponding property value node. Based on the execution of the atomic rules, atomic rule outcomes may be generated. Further, atomic rule outcomes nodes may be generated to represent the atomic rule outcomes. Based on the atomic rule outcomes for each property instance node, composite rule nodes representing composite rules may be identified, using the rule graph. The composite rule node may be associated with the two or more executed atomic rule nodes, each having an atomic rule outcome that is true. The operation associated with the stimulus may be further executed based on the identified composite rule nodes. Based on the execution of the composite rules, composite rule outcomes may be generated. Further, composite rule outcomes nodes may be generated to represent the composite rule outcomes. The operation associated with the stimulus may be executed based on the data instance node, the property instance nodes, the property value nodes, the atomic rule nodes associated with each property template node, and the composite rule nodes.

The atomic and composite rule execution may continue until all the related rules are executed and a final outcome is generated. The generated inference graph, that comprises the data instance node, the property instance nodes, the property value nodes, the atomic rule nodes, the atomic rule outcomes nodes, the composite rule nodes, and the composite rule outcomes nodes may be stored in storage circuitry for various purposes. For example, the inference graph may be utilized for audit tracking, decision traceability, error and/or inconsistency detection, or the like.

Such a solution allows efficient identification of the required rules for faster execution of the operation associated with the stimulus. Further, the inference graph may provide an explainability for the decisions made. This may further provide transparent and interpretable reasoning behind the decisions, thus, leveraging the inference graph as an understandable graph. Additionally, the structure of the inference graph may allow quick identification and subsequent correction of any inconsistencies associated therewith. The relational databases may pose difficulty in tracking such inconsistencies. Decision-making based on such inconsistencies may prove to be fatal in sectors such as healthcare, finance, or the like. It is appreciated that the human mind is not equipped to conceptualize an optimized identification of the required rule nodes for execution thereof on the property value nodes based on the association of the property value nodes with the rule nodes, given the digital interconnectedness of the association.

The present disclosure provides numerous advantages including optimized and organized association of rule nodes with the property template nodes. The association may further allow efficient identification of the required rules for faster execution of the operation associated with a stimulus. Notably, the excessive database lookups may be prevented which may further lead to faster decision making with significant ease and reduced time consumption. Further, the present disclosure provides an explainability for the decisions made, thereby providing transparency and interpretability for the decisions made. Application areas of the present disclosure may include domains that require complex decision-making and reasoning for the decisions made (for example, healthcare, finance, or the like).

### Figure Description

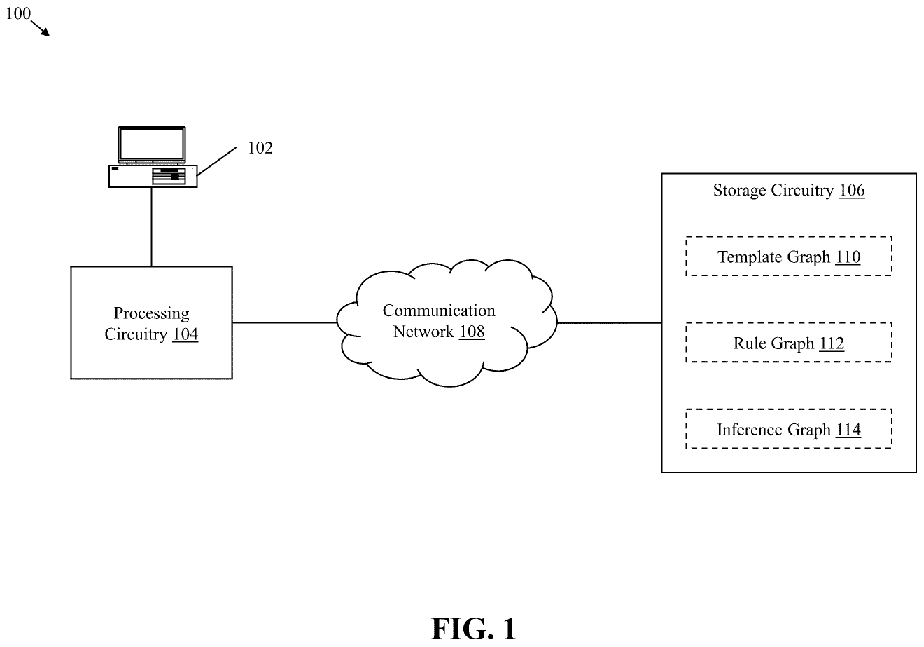

FIG. 1 is a block diagram that illustrates a system environment 100 for an inference engine using directed property graphs, consistent with disclosed embodiments of the present disclosure. In decision-centric sectors, such as healthcare, electronic commerce (e-commerce), finance, banking, or the like, making accurate, timely, and informed decisions is of utmost priority. Decision-making in these sectors may be based on analyzing raw data (e.g., facts) using predefined rules, deriving partial or intermediate conclusions based on the analysis, integrating these intermediate insights, and deriving a final decision. For example, for the diagnosis of a disease, a doctor may analyze the available notes on the patient's symptoms and note a combination of fever and rash. The doctor may then determine that the symptoms may be pointing toward a viral infection and prescribe a requisite treatment. In other words, for arriving at a decision, a structured process of analysis and reasoning of the available data may be required, where intermediate conclusions may generate new facts that may be further evaluated. These conclusions and evaluations are typically guided by the execution of rules. Further, these facts, in turn, may lead to subsequent inferences, thereby forming interconnected reasoning steps that may lead to the final decision.

Typically, the data and the rules may be stored in various databases (such as a relational database, a non-relational database, or the like). The stored data and the rules can be utilized for various use cases by way of query processing. Efficient retrieval of the data and the rules from the databases may play an important role in query processing. Therefore, the structure of the data storage may directly influence the query performance. That is to say, suboptimal data storage structure can lead to significant inefficiencies, such as increased query latency, higher computational costs, higher storage requirements, or the like. Such delays or inefficiencies can hinder time-sensitive tasks and may negatively affect the overall performance.

The present disclosure provides a solution to implement accurate and efficient data analysis for decision-making by storing data and rules in directed property graphs. A directed property graph is a graph data model consisting of nodes, edges, and properties, where edges have direction and both nodes and edges can store key-value pairs, allowing for complex data representation and efficient querying. Referring to FIG. 1, the system environment 100 may include a real-time system 102, processing circuitry 104, storage circuitry 106, and a communication network 108. The storage circuitry 106 may be configured to store a template graph 110, a rule graph 112, and an inference graph 114. Each of the template graph 110, the rule graph 112, and the inference graph 114 may correspond to a directed property graph. The processing circuitry 104 may be coupled to the storage circuitry 106 and may be configured to access the storage circuitry 106 via the communication network 108.

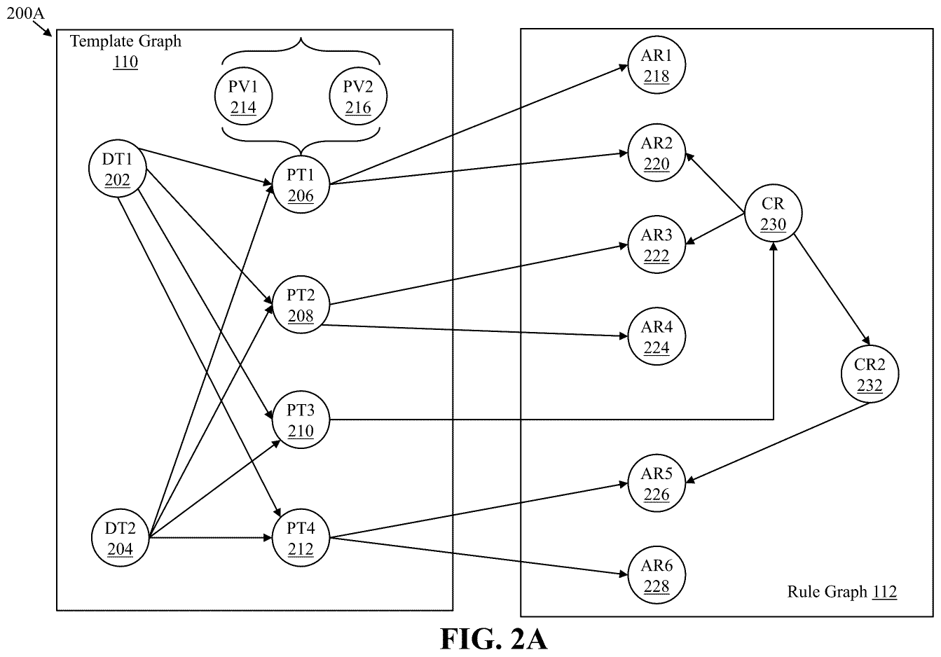

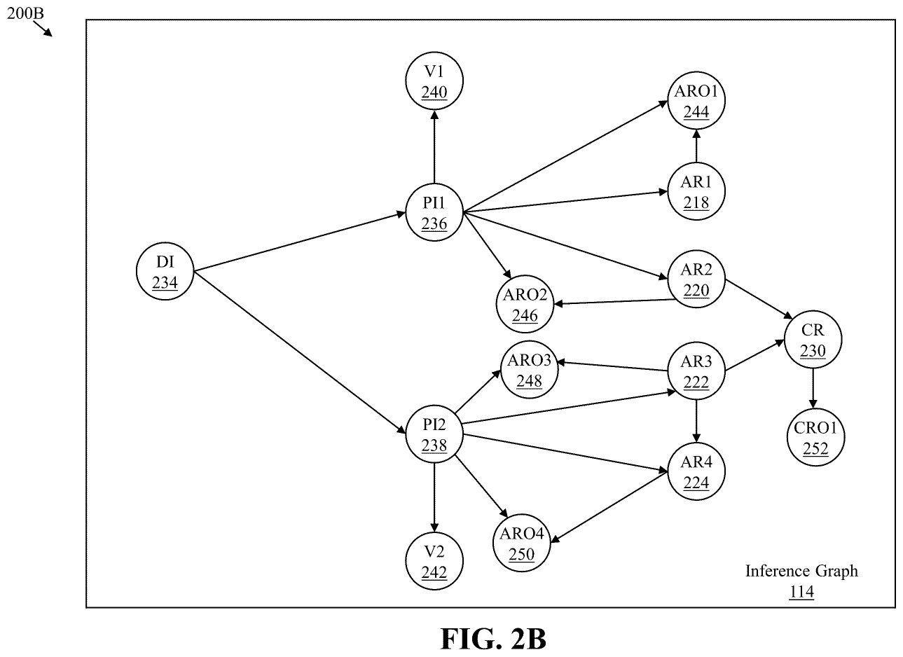

The template graph 110 may correspond to a directed property graph derived from a dataset. The dataset may represent the available information that may be utilized for decision-making. Each data record within the dataset may correspond to an entity associated with the real-time system 102. Each entity may be associated with various properties having property values thereof. In the template graph 110, each of the entities and the properties associated with the corresponding entity may be represented as data template nodes and property template nodes, respectively. Further, the property values of the corresponding properties may also be represented as property value nodes in the template graph 110. The structure of the template graph 110 is explained in detail in FIG. 2A.

The rule graph 112 may correspond to a directed property graph representing a repository of rules. The rules may be atomic rules and/or composite rules. The atomic rules may correspond to fact rules that may be executed on property values. The composite rules may be executed based on the outcomes of the atomic rules. The rule graph 112 includes rule nodes for each atomic and composite rule. The structure of the rule graph 112 is explained in detail in FIG. 2A.

The inference graph 114 may be generated based on a stimulus. The inference graph 114 may be generated by utilizing the data template nodes from the template graph 110 and the atomic and composite rule nodes from the rule graph 112. The generated inference graph 114 may be stored in the storage circuitry 106 for various real-time operations. The structure of the inference graph 114 is explained in detail in FIG. 2B.

The real-time system 102 may represent a distributed platform that encompasses various microservices for the resolution of real-world problems. Each microservice may be associated with various entities and may have data associated therewith. For example, in a healthcare microservice, the entities may correspond to patients and the data may correspond to patient details, such as name, address, historical health records, or the like. Each microservice may require analysis of the data for decision-making. Therefore, efficient retrieval of data and rules may be required for efficient decision-making.

The processing circuitry 104 may include suitable logic, circuitry, interfaces, and/or code, executable by the circuitry, that may be configured to perform optimized data analysis. The processing circuitry 104 may be configured to generate (e.g., derive) an inference graph 114 based on the data and the rules associated with the real-time system 102, and store the inference graph 114 in the storage circuitry 106. Examples of the storage circuitry 106 may include, but are not limited to, a random-access memory (RAM), a read-only memory (ROM), a removable storage drive, a hard disk drive (HDD), a flash memory, a solid-state memory, or the like.

In some embodiments, the processing circuitry 104 may be configured to generate the template graph 110 and the rule graph 112. The template graph 110 may be generated based on a user request of a user associated with the real-time system 102 that may prompt the processing circuitry 104 to collect relevant data, structure the relevant data, generate a dataset, and store the dataset in the storage circuitry 106 as the template graph 110. Further, the user may design the rules for the dataset based on operational requirements. The processing circuitry 104 may be further configured to structure the rules designed by the user, generate the rule graph 112, and store the generated rule graph 112 in the storage circuitry 106.

### Generation of the Inference Graph 114

The inference graph 114 may be generated based on a stimulus. The stimulus may correspond to a decision-making operation for an entity of the real-time system 102. To generate the inference graph 114, the processing circuitry 104 may be configured to create a data instance node that represents the entity. The data instance node may have an instance identifier (ID) and a template ID associated therewith. Further, the entity may have properties associated therewith. The processing circuitry 104 may be configured to generate property instance nodes for these properties. Each property may have a property value. To represent the property values of the properties, the processing circuitry 104 may be configured to generate property value nodes.

Using the template graph 110, the processing circuitry 104 may be further configured to identify a data template node corresponding to the data instance node. The identified data template node may have the same ID as the template ID of the generated data instance node. Upon the identification of the data template node, the processing circuitry 104 may be further configured to identify the property template nodes associated with the data template node based on the generated property value nodes. Further, the processing circuitry 104 may be configured to identify, using the rule graph 112, atomic rule nodes associated with each property template node. The processing circuitry 104 may be further configured to associate the atomic rule nodes with the generated property instance nodes.

The processing circuitry 104 may be further configured to execute, for each property instance node, the atomic rules represented by the atomic rule nodes on the property value represented by the corresponding property value node. Based on the execution of the atomic rules, the processing circuitry 104 may be further configured to generate atomic rule outcomes. Further, the processing circuitry 104 may be configured to generate atomic rule outcome nodes to represent the atomic rule outcomes.

Based on the atomic rule outcomes for each property instance node and using the rule graph 112, the processing circuitry 104 may be configured to identify composite rule nodes representing composite rules. Further, the processing circuitry 104 may be configured to associate a composite rule node with the two or more executed atomic rule nodes, each having an atomic rule outcome that is true. The operation associated with the stimulus may be further executed based on the identified composite rule nodes. Based on the execution of the composite rules, the processing circuitry 104 may be configured to generate composite rule outcomes. Further, the processing circuitry 104 may be configured to generate composite rule outcomes nodes to represent the composite rule outcomes. Thus, the processing circuitry 104 may be configured to execute the operation associated with the stimulus based on the data instance node, the property instance nodes, the property value nodes, the atomic rule nodes associated with each property template node, and the composite rule nodes.

The processing circuitry 104 may continue the execution of the atomic and composite rules until all the related rules are executed. The processing circuitry 104 may generate a final outcome based on the execution of all the related rules. Further, the processing circuitry 104 may be configured to store the generated inference graph 114, that comprises the data instance node, the property instance nodes, the property value nodes, the atomic rule nodes, the atomic rule outcomes nodes, the composite rule nodes, and the composite rule outcomes nodes for various purposes. For example, the inference graph 114 may be utilized for audit tracking, decision traceability, error and/or inconsistency detection, or the like.

Thus, the present disclosure provides numerous advantages including optimized and organized association of rule nodes with the property template nodes. The association may further allow efficient identification of the required rules for faster execution of the operation associated with a stimulus. Notably, the excessive database lookups may be prevented which may further lead to faster decision making with significant ease and reduced time consumption. Further, the present disclosure provides an explainability for the decisions made, thereby providing transparency and interpretability for the decisions made.

The processing circuitry 104 may be implemented by one or more processors, such as, but not limited to, an application-specific integrated circuit (ASIC) processor, a reduced instruction set computer (RISC) processor, a complex instruction set computer (CISC) processor, and a field programmable gate array (FPGA) processor. The one or more processors may also correspond to central processing units (CPUs), graphics processing units (GPUs), neural processing units (NPUs), digital signal processors (DSPs), or the like. It will be apparent to a person of ordinary skill in the art that the processing circuitry 104 may be compatible with multiple operating systems. The processing circuitry 104 may further include one or more components (for example, a parser, a loader, or the like) that may be configured to execute one or more operations to be executed by the processing circuitry 104.

The communication network 108 is a medium through which instructions and data are transmitted between the processing circuitry 104 and the storage circuitry 106. Examples of the communication network 108 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, microwave communication, and a combination thereof. Examples of the communication network 108 may further include a Narrow Band-Internet of Things (NB-IoT) network, a 5G network, a 4G network, a long-range (LoRa) wireless technology network, a ZigBee network, an IPv6 Low-power Wireless Personal Area Network (6LowPAN), or the like. Various entities (such as the processing circuitry 104 and the storage circuitry 106) in the system environment 100 may be coupled to the communication network 108 in accordance with various wired and wireless communication protocols, such as Transmission Control Protocol and Internet Protocol (TCP/IP), User Datagram Protocol (UDP), Long Term Evolution (LTE) communication protocols, or any combination thereof.

Although the present disclosure describes the generation and utilization of a directed property graph, the scope of the present disclosure is not limited to it. In numerous embodiments, other types of graphs, such as undirected graphs, weighted graphs, bipartite graphs, or the like, may be utilized without deviating from the scope of the present disclosure.

The scope of the present disclosure is not limited to a standalone realization of the storage circuitry 106, as described herein. In numerous embodiments, the storage circuitry 106 can be realized in the form of a database server or a cloud storage working in conjunction with the processing circuitry 104, without departing from the scope of the present disclosure.

FIG. 2A is a schematic diagram 200A that illustrates an association between the template graph 110 and the rule graph 112, consistent with disclosed embodiments of the present disclosure.

As described in FIG. 1, the template graph 110 may represent a dataset. The dataset may comprise various features that may represent descriptive aspects of the data. Further, each data record of the dataset may correspond to an entity associated with the real-time system 102. The entity may have one or more properties associated therewith, with a property having a set of property values. In an embodiment, the dataset may correspond to a bank account management dataset. In such a scenario, each data record may correspond to a customer. The customer may be associated with properties such as an account type, a region, customer benefits, an age group, recommendation plans, or the like. The properties may thus represent the features of the bank account management dataset, providing the necessary dimensions for deriving insights and making informed decisions. Further, each property may have one or more property values associated therewith. For example, the property values of the account type may correspond to a premium account type and a savings account type, the property values of the region may correspond to an urban region and a rural region, and the property values of the customer benefits may correspond to urban premium benefits and rural premium benefits. Similarly, the property values of the age group may correspond to major and senior citizen, and the property values of the recommendation plans may correspond to a premium savings plan and a premium loan plan. The customer may have properties other than the ones mentioned above, and each property may have various other property values, without deviating from the scope of the present disclosure.

The template graph 110 may include a plurality of data template nodes, of which data template nodes 202 and 204 are shown in FIG. 2A. Each of the data template nodes 202 and 204 may represent an entity associated with the real-time system 102 and may be associated with an ID. In an example, the data template node 202 may represent a first customer and the data template node 204 may represent a second customer included within the bank account management dataset. The template graph 110 may further include a plurality of property template nodes, of which property template nodes 206-212 are shown in FIG. 2A. The property template nodes 206-212 may represent properties associated with the entity. For example, the property template nodes 206-212 may be associated with a customer of the bank and may represent the account type, the region, the customer benefits, and the age group of the customer, respectively. For the sake of simplicity, the property template node for the recommendation plans is not shown in FIG. 2A.

Further, each data template node (for example, the data template nodes 202 and 204) may be associated with one or more property template nodes of the plurality of property template nodes. The association between the data template node and property template nodes may be executed by way of edges. As shown in FIG. 2A, both the data template nodes 202 and 204 are associated with the property template nodes 206-212. The scope of the present disclosure is however not limited to it, and in several embodiments, a property template node may be associated with exclusively one data template node.

The template graph 110 may further comprise a plurality of property value nodes, of which property value nodes 214 and 216 are shown in FIG. 2A. Each property template node may be associated with one or more property value nodes of the plurality of property value nodes. Each property value node, of one or more property value nodes, may represent a property value of the one or more property values of the property represented by the corresponding property template node. For example, the property template node 206 representing the account type is shown to be associated with the property value nodes 214 and 216. The property value of the property value node 214 may correspond to the savings account type and the property value of the property value node 216 may correspond to the premium account type. The property template nodes 208-212 are not shown to be associated with corresponding property value nodes in FIG. 2A to keep the illustration concise and clear. However, property value nodes for the property template nodes 208-212 may be associated in a similar manner.

As described previously, the system operation associated with the real-time system 102 may require analysis of the data for making a decision. The analysis of the data may be performed by execution of various rules. Thus, FIG. 2A is further shown to include the rule graph 112. The rule graph 112 may correspond to a repository of rules. The repository of rules may represent a structured collection of predefined logic or conditions that may be utilized to analyze the data and derive conclusions. Typically, a rule consists of two components: a left-hand side (LHS) and a right-hand side (RHS). The LHS represents a conditional statement (or antecedent) that is evaluated based on input data. If the condition on the LHS is satisfied, the rule is triggered. The RHS defines the outcome or action to be taken when the LHS condition is met. Formally, if P represents the condition on the LHS and Q represents the action or result on the RHS, the logical structure of the rule can be expressed as P→Q, that is, if P is true, then return Q.

The rule graph 112 may include a plurality of atomic rule nodes, of which atomic rule nodes 218-228 are shown in FIG. 2A. Each property template node (for example, the property template nodes 206-212) may be associated with a set of atomic rule nodes by way of edges. The set of atomic rule nodes may represent a set of atomic rules to be executed on the set of property values of the property represented by the corresponding property template node. An outcome of an atomic rule may be true or false. For example, the property template node 206 is shown to be associated with the atomic rule nodes 218 and 220. Each of the atomic rule nodes 218 and 220 may represent an atomic rule. For example, the atomic rule represented by the atomic rule node 218 may be defined as:

IF account type==savings, THEN return true;

That is to say, the atomic rule is executed on a property value savings of the property account type to verify whether the account type corresponds to the savings account type.

Similarly, the atomic rule represented by the atomic rule node 220 may be defined as:

IF account type==premium, THEN return true;

That is to say, the atomic rule verifies whether the account type corresponds to the premium account type.

Similarly, the atomic rule nodes 222 and 224 associated with the property template node 208 may represent atomic rules. For example, the atomic rule represented by the atomic rule node 222 may be defined as:

IF region==urban, THEN return true;

That is to say, the atomic rule verifies whether the region corresponds to the urban region. Further, the atomic rule represented by the atomic rule node 224 may be defined as:

IF region==rural, THEN return true;

That is to say, the atomic rule verifies whether the region corresponds to the rural region.

Similarly, the atomic rule nodes 226 and 228 associated with the property template node 212 may represent atomic rules. For example, the atomic rule represented by the atomic rule node 226 may be defined as:

IF age group==major, THEN return true;

That is to say, the atomic rule verifies whether the age group corresponds to the major age group. Further, the atomic rule represented by the atomic rule node 228 may be defined as:

IF age group ==senior citizen, THEN return true;

That is to say, the atomic rule verifies whether the age group corresponds to the senior citizen age group.

The rule graph 112 may further include a plurality of composite rule nodes, of which composite rule nodes 230 and 232 are shown in FIG. 2A. Each of the plurality of composite rule nodes may represent a composite rule. Composite rules are the rules whose execution relies on the outcome of other rules (e.g., atomic rules and/or other composite rules). The outcomes generated based on the execution of these other rules may act as input to the composite rules to perform further analysis. That is to say, each of the composite rule nodes 230 and 232 representing the corresponding composite rules may be dependent on the outcomes of other rules.

The composite rule node 230 is shown to be dependent on the atomic rule node 220 and the atomic rule node 222 by way of edges. In one embodiment, the composite rule represented by the composite rule node 230 may be executed when the rule outcome associated with each of the atomic rule node 220 and the atomic rule node 222 is true. That is to say, the composite rule represented by the composite rule node 230 is dependent on two or more executed atomic rule nodes, each having an atomic rule outcome that is true.

The scope of the present disclosure is not limited to the composite rule being executed when all rule outcomes of associated rule nodes are true. In another embodiment, the composite rule represented by the composite rule node 230 may be executed exclusively when the rule outcome associated with at least one of the atomic rule nodes 220 and 222 is true. In other words, the composite rule node 230 is dependent on the executed atomic rule nodes 220 and 222 having at least one atomic rule outcome that is true.

Additionally, the composite rule represented by the composite rule node 230 is shown to be associated with the property template node 210 by way of an edge. The association between the composite rule node 230 and the property template node 210 may indicate an operational dependency between the composite rule represented by the composite rule node 230 and the customer benefits property represented by the property template node 210 for execution of the composite rule. Thus, the composite rule being represented by the composite rule node 230 may be defined as:
IF the customer has a premium account type AND belongs to an urban region, THEN return the urban premium benefits the customer is eligible for.

Although FIG. 2A describes one composite rule node being dependent on two atomic rule nodes, the scope of the present disclosure is not limited to it. In several embodiments, one composite rule node may be dependent on more than two atomic rule nodes, without deviating from the scope of the present disclosure.

The composite rule node 232, on the other hand, is dependent on the composite rule node 230 and the atomic rule node 226. The composite rule represented by the composite rule node 232 may be executed exclusively when the rule outcome associated with the composite rule node 230 and the atomic rule node 226 is true. In other words, the composite rule node 232 is dependent on the executed atomic rule node 226 having an atomic rule outcome that is true, and the executed composite rule node 230 having a composite rule outcome that is true. Thus, the composite rule being represented by the composite rule node 232 may be defined as:
IF the customer has the urban premium benefits AND belongs to a major age group, THEN return the premium loan plan recommendation the customer is eligible for.

Having described the template graph 110 and the rule graph 112, the discussion will now move to the utilization of the template graph 110 and the rule graph 112 to generate the inference graph 114. The generation and utilization of the inference graph 114 is explained in detail in conjunction with FIG. 2B.

FIG. 2B is a schematic diagram 200B that illustrates the generation and utilization of the inference graph 114 by utilizing the template graph 110 and the rule graph 112, consistent with disclosed embodiments of the present disclosure.

In some embodiments, the generation of the inference graph 114 may be predominantly based on a stimulus associated with the real-time system 102. That is to say, generation of the inference graph 114 may be based on a context associated with the stimulus. For example, the context may correspond to the details required for a decision-making operation associated with the stimulus. Based on the details associated with the stimulus, relevant rules (for example, the atomic rules) may be identified and executed, and the rule execution may generate new inference results. Generation of the new inference results may lead to further identification and execution of other relevant rules requiring evaluation (for example, the atomic and/or composite rules). This iterative process of analysis and reasoning may continue until all the applicable rules have been identified and executed, ultimately leading to the generation of an accurate decision for the operation associated with the stimulus.

In an embodiment, the processing circuitry 104 may be configured to receive a stimulus. The stimulus may be indicative of an operation to determine the suitable recommendation plan for the first customer. The stimulus may comprise the required details of the first customer. That is to say, the stimulus may comprise one or more properties associated with the first customer such as the ID of the first customer, the account type of the first customer, the region of the first customer, and the age group of the first customer. In an embodiment, the ID of the first customer may correspond to ‘1’. The account type of the first customer may correspond to the premium account type, the region of the first customer may correspond to the urban region, and the age group of the first customer may correspond to the major age group.

To execute the operation associated with the stimulus, the processing circuitry 104 may be further configured to generate the inference graph 114. To generate the inference graph 114, the processing circuitry 104 may be configured to generate, based on the stimulus, a data instance node 234, a set of property instance nodes associated with the data instance node 234, and a set of property value nodes associated with the set of property instance nodes. The inference graph 114 is shown to include property instance nodes 236 and 238 and property value nodes 240 and 242 representing the property values of the property instance nodes 236 and 238, respectively. Each of the data instance node 234, the property instance nodes 236 and 238, and the property value nodes 240 and 242 may have an ID associated therewith.

The data instance node 234 may be indicative of the first customer associated with the real-time system 102. In an embodiment, the template ID of the data instance node 234 may be identical to the ID associated with the first customer. The property instance nodes 236 and 238 may represent the one or more properties of the first customer. For example, the property instance node 236 may represent the account type of the first customer, whereas the property instance node 238 may represent the region of the first customer. In an embodiment, the processing circuitry 104 may be configured to associate the property instance nodes 236 and 238 with the data instance node 234 by way of edges. For the sake of simplicity, property instance nodes representing other properties of the first customer are not shown in the inference graph 114. However, property instance nodes representing the other properties of the first customer may also be represented and associated with the data instance node 234 in a similar manner.

Further, the property value of the property value node 240 may correspond to premium account type and the property value of the property value node 242 may correspond to urban region. In an embodiment, the processing circuitry 104 may be configured to associate the property value node 240 with the property instance node 236 and the property value node 242 with the property instance node 238 by way edges. For the sake of simplicity, the property value node for the age group is not shown in FIG. 2B. However, a property value node for the age group may be generated in a similar manner.

The processing circuitry 104 may be further configured to identify, using the template graph 110, a data template node corresponding to the data instance node 234. As mentioned above, each data template node, of the plurality of data template nodes, has an ID associated therewith. Further, the data instance node 234 has an instance ID and a template ID associated therewith. The processing circuitry 104 identifies, from the plurality of data template nodes, the data template node 202 corresponding to the data instance node 234 based on the ID of the data template node 202 matching the template ID of the data instance node 234. In an embodiment, the ID of the data template node 202 may match the ID of the data instance node 234. Thus, the processing circuitry 104 may be further configured to identify the data template node 202 corresponding to the data instance node 234.

The data template node 202 has one or more property template nodes (e.g., the property template nodes 206-212) associated therewith. The processing circuitry 104 may be further configured to identify a set of property template nodes corresponding to the set of property instance nodes (e.g., the property instance nodes 236 and 238). The processing circuitry 104 identifies the set of property template nodes from the one or more property template nodes associated with the identified data template node 202. Thus, the processing circuitry 104 may identify the set of property template nodes corresponding to the set of property instance nodes based on the template graph 110 and the data instance node 234.

Each of the identified set of property template nodes has at least one property value node that matches one of the set of property value nodes (e.g., the property value nodes 240 and 242) generated based on the stimulus. For example, the processing circuitry 104 may identify the property template node 206 and the property template node 208. The processing circuitry 104 may identify the property template node 206 as the property value node 216 (for example, premium account type) matches the property value node 240. Similarly, the processing circuitry 104 may identify the property template node 208 based on a property value node of the property template node 208 matching the property value node 242. Similarly, the processing circuitry 104 may identify the property template node 212 based on a property value node of the property template node 212 matching a property value node associated with a property instance node representing the age group.

Each of the property template nodes 206 and 208 has a set of atomic rule nodes associated therewith. The processing circuitry 104 may be configured to identify, using the rule graph 112, the set of atomic rule nodes associated with each of the set of property template nodes (e.g., the property template nodes 206 and 208). For example, the processing circuitry 104 may be further configured to identify the atomic rule nodes 218 and 220 associated with the property template node 206. The processing circuitry 104 may be further configured to associate the identified set of atomic rule nodes with the corresponding property instance node by way of edges. For example, the processing circuitry 104 may be further configured to associate the atomic rule nodes 218 and 220 with the property instance node 236. Similarly, the processing circuitry 104 may be further configured to associate the atomic rule nodes 222 and 224 with the property instance node 238.

The processing circuitry 104 may be further configured to execute an operation associated with the stimulus based on at least one of a group consisting of the set of property instance nodes (e.g., the property instance nodes 236 and 238), the set of property value nodes (e.g., the property value nodes 240 and 242), and the set of atomic rule nodes identified for each of the set of property template nodes (e.g., the atomic rule nodes 218 and 220 identified for the property template node 206, and the atomic rule nodes 222 and 224 identified for the property template node 208). To execute the operation, the processing circuitry 104 may be further configured to execute the atomic rules represented by the atomic rule nodes 218 and 220 on the property value represented by the property value node 240. Similarly, the processing circuitry 104 may be further configured to execute the atomic rules represented by the atomic rule nodes 222 and 224 on the property value represented by the property value node 242. In other words, to execute the operation, the processing circuitry 104 may be further configured to execute, for each property instance node of the set of property instance nodes, the set of atomic rules represented by the corresponding set of atomic rule nodes on a property value represented by the corresponding property value node.

The processing circuitry 104 may be further configured to generate a set of atomic rule outcomes for the execution of the set of atomic rules associated with each property instance node of the set of property instance nodes. Further, an atomic rule outcome of the set of atomic rule outcomes may correspond to true or false. For example, the processing circuitry 104 may be configured to execute the atomic rules represented by the atomic rule nodes 218 and 220 on the property value premium account type represented by the property value node 240. For example, the processing circuitry 104 may execute the atomic rule represented by the atomic rule node 218 that verifies whether the account type of the first customer corresponds to the savings account type. However, the property value represented by the property value node 240 corresponds to the premium account type, therefore, the atomic rule outcome may correspond to ‘false’. The processing circuitry 104 may be further configured to execute the atomic rule represented by the atomic rule node 220 on the property value premium account type represented by the property value node 240, that verifies whether the account type of the first customer corresponds to the premium account type. As the property value represented by the property value node 240 corresponds to the premium account type, the atomic rule outcome may correspond to ‘true’.

The processing circuitry 104 may be further configured to generate atomic rule outcome nodes 244 and 246 to represent the generated atomic rule outcomes for the atomic rule nodes 218 and 220, respectively. That is to say, the atomic rule outcome node 244 may represent the atomic rule outcome ‘false’, whereas the atomic rule outcome node 246 may represent the atomic rule outcome ‘true’. The processing circuitry 104 may be further configured to associate the atomic rule outcome nodes 244 and 246 with the property instance node 236 by way of edges. Further, the processing circuitry 104 may be configured to associate the atomic rule node 218 with the atomic rule outcome node 244 and the atomic rule node 220 with the atomic rule outcome node 246 by way of edges.

Similarly, the processing circuitry 104 may be further configured to generate atomic rule outcome nodes 248 and 250 to represent the generated atomic rule outcomes for the atomic rule nodes 222 and 224, respectively. That is to say, the atomic rule outcome node 248 may represent the atomic rule outcome ‘true’, whereas the atomic rule outcome node 250 may represent the atomic rule outcome ‘false’. The processing circuitry 104 may be further configured to associate the atomic rule outcome nodes 248 and 250 with the property instance node 238 by way of edges. Further, the processing circuitry 104 may be configured to associate the atomic rule node 222 with the atomic rule outcome node 248 and the atomic rule node 224 with the atomic rule outcome node 250 by way of edges.

Thus, the processing circuitry 104 may be further configured to generate a set of atomic rule outcome nodes for the set of atomic rule outcomes generated for each property instance node of the set of property instance nodes and associate the set of atomic rule outcome nodes with the corresponding property instance node.

Although not shown in the inference graph 114, the processing circuitry 104 may be further configured to execute the atomic rule represented by the atomic rule node 226 that verifies whether the age group of the first customer corresponds to major. As the first customer corresponds to the major age group, the atomic rule outcome may correspond to ‘true’. The processing circuitry 104 may be further configured to execute the atomic rule represented by the atomic rule node 228 that verifies whether the age of the group of the first customer corresponds to senior citizen. As the first customer corresponds to the major age group, the atomic rule outcome may correspond to ‘false’. The processing circuitry 104 may be further configured to generate atomic rule outcome nodes for the corresponding atomic rule outcomes and associate the atomic rule outcome nodes with a property instance node representing the age group of the first customer. Further, the processing circuitry 104 may be configured to associate the atomic rule nodes with the corresponding atomic rule outcome nodes.

Based on the atomic rule outcomes being true for the atomic rules represented by the atomic rule node 220 and the atomic rule node 222, the processing circuitry 104 may be configured to identify the composite rule node 230. In other words, based on the set of atomic rule outcomes generated for each property instance node of the set of property instance nodes, the processing circuitry 104 may be further configured to identify, using the rule graph 112, one or more composite rule nodes. In such a scenario, the operation associated with the stimulus is executed further based on the one or more composite rule nodes (e.g., the composite rule node 230).

The processing circuitry 104 may be further configured to associate each of the one or more composite rule nodes with the corresponding two or more executed atomic rule nodes. To execute the operation, the processing circuitry 104 may be further configured to execute one or more composite rules represented by the one or more composite rule nodes based on two or more atomic rule outcomes of the dependent two or more executed atomic rule nodes, respectively. Based on an execution of the one or more composite rules, the processing circuitry 104 may be further configured to generate one or more composite rule outcomes, respectively. The processing circuitry 104 may be further configured to generate one or more composite rule outcome nodes for the one or more composite rule outcomes, respectively.

For example, the processing circuitry 104 may associate the composite rule node 230 with the executed atomic rule nodes 220 and 222 by way of edges. Further, to execute the operation, the processing circuitry 104 may execute the composite rule represented by the composite rule node 230 based on the atomic rule outcomes of the executed atomic rule nodes 220 and 222. The composite rule represented by the composite rule node 230 is designed to determine suitable customer benefits for a customer associated with the real-time system 102. Thus, the LHS part of the composite rule may verify whether the account type of the first customer is premium account type and the region of the first customer is urban region. Based on both the conditions being satisfied, the RHS part of the composite rule may be executed. The RHS part of the composite rule may determine the customer benefit that the first customer is eligible for by evaluating the set of property values (for example, the urban premium benefits and the rural premium benefits) associated with the property template node 210 and return the determined customer benefit. Thus, the composite rule represented by the composite rule node 230 is executed based on the atomic rule outcomes of the atomic rules represented by the atomic rule nodes 220 and 222 being true.

Based on the execution, the processing circuitry 104 may be configured to generate a composite rule outcome. In the ongoing discussion, as the first customer has the premium account type and belongs to an urban region, the first customer may be benefitted with the urban premium benefits. That is to say, the composite rule outcome for composite rule represented by the composite rule node 230 corresponds to urban premium benefits. Notably, the composite rule outcome corresponds to a property value associated with the data instance node 234 that represents the first customer. Thus, based on the association between the composite rule node 230 and the property template node 210, the property values associated with the customer benefits property may be assessed for execution of the composite rule represented by the composite rule node 230 to generate the corresponding composite rule outcome. The processing circuitry 104 may be further configured to generate a composite rule outcome node 252 to represent the generated composite rule outcome urban premium benefits. The processing circuitry 104 may be further configured to associate the composite rule outcome node 252 with the composite rule node 230 by way of an edge.

In an embodiment, the successful generation of the composite rule outcome may return a composite rule outcome true that may trigger the identification of other related rules. That is to say, based on the execution of the composite rule represented by the composite rule node 230, the processing circuitry 104 is further configured to identify, using the rule graph 112, at least one other composite rule node that is dependent on one or more executed atomic rule nodes having atomic rule outcomes that are true (for example, the atomic rule node 226), or one or more executed composite rule nodes (for example, the composite rule node 230) having composite rule outcomes that are true. In an embodiment, the processing circuitry 104 may be configured to identify the composite rule node 232. The execution of the operation associated with the stimulus may be further executed based on the composite rule node 232.

The composite rule represented by the composite rule node 232 is designed to determine a suitable recommendation plan for a customer associated with the real-time system 102 based on certain criteria. For example, the customer should be associated with a premium account type, should belong to an urban region, and the age of the customer should be major. To execute the operation associated with the stimulus, the processing circuitry 104 may be further configured to associate the composite rule node 232 with the composite rule node 230 and the property instance node that may represent the property age group in the inference graph 114.

Thus, the LHS part of the composite rule may verify whether the first customer has urban premium benefits and whether the age group of the first customer is major. Based on both the conditions being satisfied, the RHS part of the composite rule may be executed. The RHS part of the composite rule may determine the suitable recommendation that the first customer is eligible for by evaluating the set of property values (for example, the premium savings plan and premium loan plan) associated with the property recommendation plan associated with the first customer and return the determined recommendation. Thus, the composite rule represented by the composite rule node 232 is executed based on the composite rule outcome of the composite rule represented by the composite rule node 230 being true and the atomic rule outcome of the executed atomic rule represented by the atomic rule node 226 being true.

Based on the execution, the processing circuitry 104 may be configured to generate a composite rule outcome. In this case, as the first customer is eligible for the urban premium benefits and belongs to the major age group, the first customer may be recommended with the premium loan plan. That is to say, the composite rule outcome for composite rule represented by the composite rule node 232 corresponds to the premium loan plan. Notably, the composite rule outcome corresponds to a property value associated with the data instance node 234 that represents the first customer. The processing circuitry 104 may be further configured to generate a composite rule outcome node to represent the generated composite rule outcome premium loan plan (not shown) and associate the generated composite rule outcome node with the composite rule node 232.

Thus, the data instance node 234, the set of property instance nodes (for example, the property instance node 236 and 238), the set of property value nodes (for example, the property value nodes 240 and 242), an association of each property instance node with the corresponding set of atomic rule nodes (for example, the atomic rule nodes 218-224), the set of atomic rule outcome nodes (for example, the atomic rule outcome nodes 244, 246, 248, and 250) for each property instance node, an association of the one or more composite rule nodes with the two or more executed atomic rule nodes (for example, the atomic rule nodes 220 and 222), and the one or more composite rule outcome nodes (for example, the composite rule outcome node 252) for the one or more composite rule outcomes, respectively, may constitute the inference graph 114. The processing circuitry 104 may be further configured to store the inference graph 114 in the storage circuitry 106.

Referring to FIGS. 2A and 2B, the structure of the template graph 110, the rule graph 112, and the inference graph 114 may allow dynamic identification and execution of the new rules based on derived insights from initial data. For example, the first customer's account type being premium and the first customer's region being urban led to the identification of the composite rule represented by the composite rule node 230. Further, the rule may infer that the first customer may be eligible for the urban premium benefits. Upon establishment of the derived insight (e.g., the eligibility of the first customer for the urban premium benefits), the derived insight may correspond to an input for identifying the subsequent rules (e.g., identification of the composite rule represented by the composite rule node 232). The composite rule represented by the composite rule node 232 may evaluate the derived benefit and the age group (for example, major) of the first customer and determine the suitable recommendation plan for the first customer (for example, the premium loan plan). Such iterations of the rules are based on previous insights and may systematically refine the outcomes. Such iterations may be executed until no new rules are applicable, thus, producing a final outcome (the premium loan plan recommendation).

The stored inference graph 114 may be utilized for various purposes such as audit tracking, decision traceability, error and/or inconsistency detection, or the like. The structure of the inference graph 114 may allow retrieval of specific information from the inference graph 114. The information retrieval from the inference graph 114 may be achieved by way of a probe. The probe may correspond to a query executed on the inference graph 114 to retrieve specific information therefrom. In an embodiment, the probe may correspond to a manual probe. For example, if the first customer associated with the bank wishes to verify why he/she is being recommended with the premium loan plan, the first customer may submit a query to the bank for verification. In such a scenario, where the query is user-initiated, the query may correspond to a manual probe.

To execute the manual probe, the processing circuitry 104 may identify the composite rule node 232 that is associated with the premium loan plan recommendation. Further, the processing circuitry 104 may identify all the underlying rules associated with the composite rule represented by the composite rule node 232. Further, the processing circuitry 104 may determine if the input values required for the execution of these rules are present in the inference graph 114. If the required input values are present, the processing circuitry 104 may be configured to execute each of the underlying rules and generate the corresponding outcome. Based on the atomic rule outcomes and the composite rule outcome, the processing circuitry 104 may determine that the first customer is recommended with the premium loan plan. In other words, the processing circuitry 104 may provide a detailed analysis to the first customer for being recommended with the premium loan plan.

Conversely, if the required input values are not present, the execution of the manual probe may be terminated. However, the scope of the present disclosure is not limited to the termination of the manual probe if the required input values are not present. In one embodiment, if the input values are not present, the processing circuitry 104 may present a request to the first customer to provide the missing input values that are required for the execution of these rules. In such an embodiment, if the required input values are provided by the first customer within a predefined time window, the processing circuitry 104 may be further configured to execute the corresponding rules. Conversely, if the required input values are not provided by the first customer within the predefined time window, the processing circuitry 104 may be further configured to terminate the execution of the manual probe.

In some embodiments, the processing circuitry 104 may sequentially determine if an input value required for each rule is present in the inference graph 114 and execute the corresponding rule. In such cases, if any input value is determined to be missing in the inference graph 114, the processing circuitry 104 may present a request to the first customer to provide the corresponding input value.

In another embodiment, the probe may correspond to an automated probe generated based on a system change event. For example, if a property value (e.g., account type) associated with the first customer changes, the inference graph 114 may be re-evaluated based on the automated probe. If the account type associated with the property value node 240 is changed to savings account type, the automated probe may trigger the determination of a suitable recommendation plan based on the changed property value. The determination may be executed in a similar manner as described above.

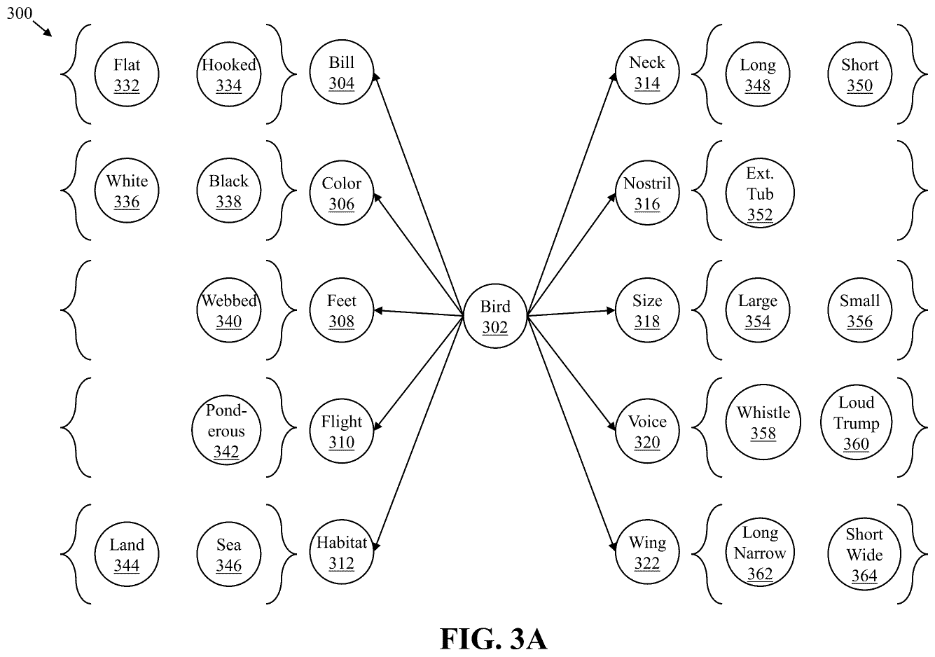

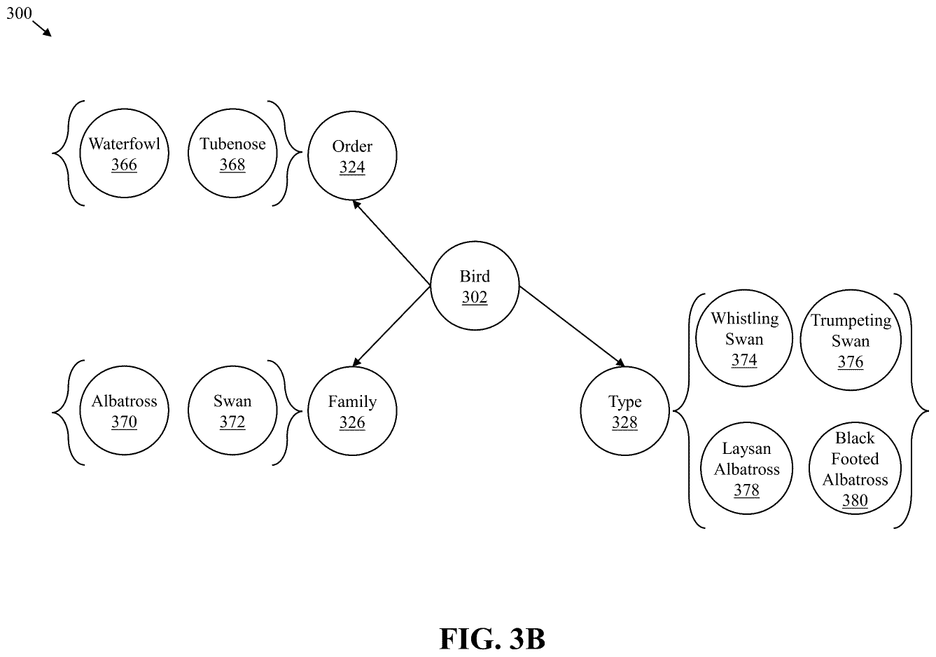

FIGS. 3A and 3B are schematic diagrams that, collectively, represent an example template graph 300, consistent with disclosed embodiments of the present disclosure.

Referring to 3A, the template graph 300 may correspond to a dataset associated with birds. The template graph 300 may create a data template node 302 that represents a bird. The data template node 302 may be associated with an ID. Further, each bird may be associated with a set of properties such as bill type, color, feet type, flight type, habitat, neck type, nostril type, size, voice, wing, order, family, and bird type. The template graph 300 may comprise a plurality of property template nodes 304-330 to represent the bill type, the color, the feet type, the flight type, the habitat, the neck type, the nostril type, the size, the voice, the wing, the order, the family, and the bird type, respectively. The data template node 302 may be associated with the plurality of property template nodes 304-328 by way of edges.

Each property of the bird may be associated with a set of property values. The template graph 300 may comprise a plurality of property value nodes such that a set of property value nodes, of the plurality of property value nodes, may represent a set of property values associated with a property of the bird. For example, the property template node 304, representing the bill type property of the bird, is shown to be associated with property value nodes 332 and 334. The property value associated with the property value node 332 may correspond to a flat bill and the property value associated with the property value node 334 may correspond to a hooked bill. The property template node 306, representing the color type property of the bird, is shown to be associated with property value nodes 336 and 338 that represent white and black colors, respectively. Similarly, the property template node 308, representing the feet type property of the bird, is shown to be associated with a property value node 340 that represents webbed feet. Further, the property template node 310, representing the flight property of the bird, is shown to be associated with a property value node 342 that represents ponderous. The property template node 312, representing the habitat property of the bird, is shown to be associated with property value nodes 344 and 346 that represent land and sea, respectively.

The property template node 314, representing the neck property of the bird, is shown to be associated with property value nodes 348 and 350 that represent long and short, respectively. The property template node 316, representing the nostril type property of the bird, is shown to be associated with a property value node 352 that represents external tubular (denoted as “Ext. Tub” in FIG. 3A). The property template node 318, representing the size property of the bird, is shown to be associated with property value nodes 354 and 356 that represent large and small, respectively. The property template node 320, representing the voice property of the bird, is shown to be associated with property value nodes 358 and 360 that represent whistle and loud trump, respectively. The property template node 322, representing the wing property of the bird, is shown to be associated with property value nodes 362 and 364 that represent long narrow and short wide, respectively.

The property template node 324, representing the order property of the bird, is shown to be associated with property value nodes 366 and 368 that represent waterfowl and tubenose, respectively. The property template node 326, representing the family property of the bird, is shown to be associated with property value nodes 370 and 372 that represent albatross and swan, respectively. Lastly, the property template node 328, representing the bird type property of the bird, is shown to be associated with property value nodes 374-380 that represent whistling swan, trumpeting swan, laysan albatross, and black footed albatross, respectively.

Although not shown, the template graph 300 may be associated with a rule graph that may comprise various atomic rule nodes and composite rule nodes. Each property template node, of the plurality of property template nodes, may be associated with a set of atomic rule nodes of the plurality of atomic rule nodes.

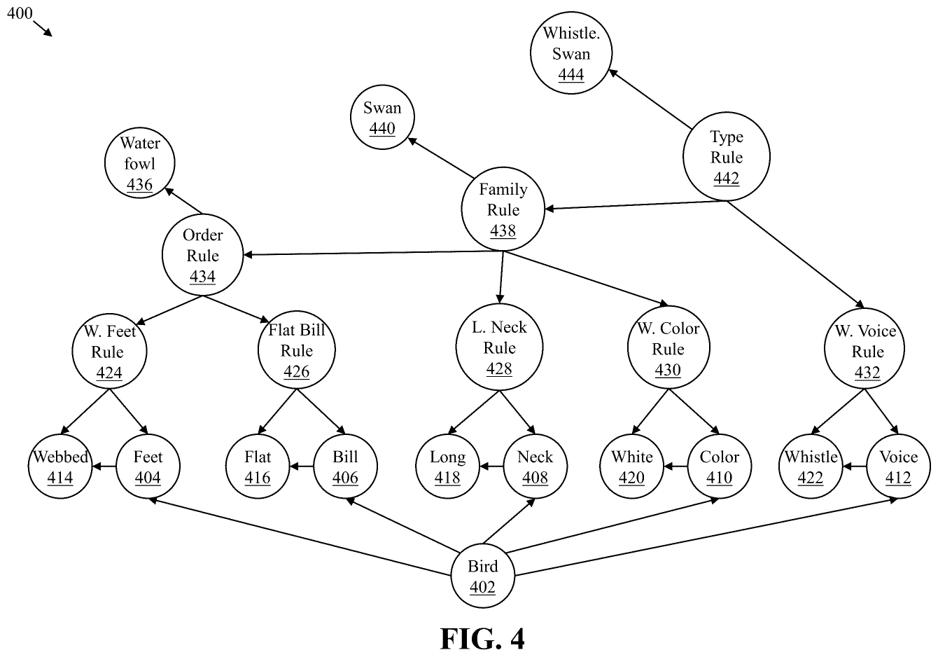

FIG. 4 is a schematic diagram that represents an example inference graph 400, consistent with disclosed embodiments of the present disclosure.

The inference graph 400 is generated based on a stimulus. The stimulus may be indicative of an operation to determine the type of a bird. The stimulus may comprise property values for certain properties associated with the bird. In an embodiment, the bird may be associated with property value ‘flat’ for the bill property, property value ‘webbed’ for the feet property, property value ‘white’ for the color property, property value ‘long’ for the neck property, and property value ‘whistle’ for the voice property.

To execute the operation associated with the stimulus, the processing circuitry 104 may be configured to generate the inference graph 400. To generate the inference graph 400, the processing circuitry 104 may be configured to create a data instance node 402 to represent the bird associated with the stimulus. Further, the processing circuitry 104 may be configured to create property instance nodes 404-412 to represent the feet property, the bill property, the neck property, the color property, and the voice property, respectively. The data instance node 402 may be associated with the property instance nodes 404-412 by way of edges. The processing circuitry 104 may be further configured to create property value nodes 414-422 to represent property values for the property instance nodes 404-412, respectively. The property value nodes 414-422 may represent the property values ‘webbed’, ‘flat’, ‘long’, ‘white’, and ‘whistle’, respectively. The processing circuitry 104 may be further configured to associate the property instance nodes 404-412 with the corresponding property value node by way of an edge.

The processing circuitry 104 may be further configured to identify the data template node 302 based on the ID of the data template node 302 matching with the template ID of the data instance node 402. Further, the processing circuitry 104 may be configured to identify, using the template graph 300, from all the property template nodes associated with the data template node 302, a set of property template nodes based on the property value nodes 414-422. For example, the processing circuitry 104 may identify the property template nodes 304, 306, 308, 314, and 322.

Further, the processing circuitry 104 may be configured to identify, using the rule graph 112, the set of atomic rule nodes associated with each of the identified property template nodes. For example, the atomic rule nodes associated with the property template node 304 may represent a set of atomic rules such as:

IF bill property==flat, THEN return true;

IF bill property ==hooked, THEN return true;

That is to say, the two atomic rules verify whether the bill of the bird corresponds to a flat bill or a hooked bill.

Similarly, the atomic rule nodes associated with the property template node 306 may represent a set of atomic rules such as:

IF color property==white, THEN return true;

IF color property==black, THEN return true;

That is to say, the two atomic rules verify whether the color of the bird corresponds to white or black.

Further, the atomic rule nodes associated with the property template node 308 may represent a set of atomic rules such as:

IF feet==webbed, THEN return true;

That is to say, the atomic rule verifies whether the feet of the bird corresponds to webbed feet.

Further, the atomic rule nodes associated with the property template node 314 may represent a set of atomic rules such as:

IF neck==long, THEN return true;

IF neck==short, THEN return true;

That is to say, the two atomic rules verify whether the neck of the bird corresponds to long or short.

Similarly, the atomic rule nodes associated with the property template node 322 may represent a set of atomic rules such as:

IF voice==whistle, THEN return true;

IF voice==loud trump, THEN return true;

That is to say, the two atomic rules verify whether the voice of the bird corresponds to a whistle or a loud trump.

The processing circuitry 104 may be configured to associate the set of atomic rule nodes with the corresponding property instance node by way of edges. Further, the processing circuitry 104 may be configured to execute, for each property instance node, the set of atomic rules represented by the corresponding set of atomic rule nodes on a property value represented by the corresponding property value node. For example, the atomic rule nodes associated with the property instance node 404 may be executed on the property value node 414 representing the property value ‘webbed’. As the bird has webbed feet, the outcome of the webbed feet rule may correspond to true. Similarly, the atomic rule nodes associated with the property instance node 406 may be executed on the property value node 416 representing the property value ‘flat’. As the bird has a flat bill, the outcome of the flat bill rule may correspond to true, whereas the outcome of the hooked bill rule may correspond to false.

The atomic rule nodes associated with the property instance node 408 may be executed on the property value node 418 representing the property value ‘long’. As the bird has a long neck, the outcome of the long neck rule may correspond to true, whereas the outcome of the short neck rule may correspond to false. Similarly, the atomic rule nodes associated with the property instance node 410 may be executed on the property value node 420 representing the property value ‘white’. As the bird has a white color, the outcome of the white color rule may correspond to true, whereas the outcome of the black color rule may correspond to false. Further, the atomic rule nodes associated with the property instance node 412 may be executed on the property value node 422 representing the property value ‘whistle’. As the bird has a whistle voice, the outcome of the whistle voice rule may correspond to true, whereas the outcome of the loud trump voice rule may correspond to false.

For the sake of simplicity, only those atomic rule nodes are shown to be associated with corresponding property instance nodes for which the atomic rule outcome corresponds to true. For example, atomic rule nodes 424-432 representing webbed feet rule, flat bill rule, long neck rule, white color rule, and whistle voice rule are shown to be associated with the property instance node 404-412, respectively. However, other atomic rule nodes may be associated with the corresponding property instance nodes in a similar manner.

The above-mentioned rules may be executed based on a query associated with the real-time system 102. Based on the execution of the atomic rules, the processing circuitry 104 may be configured to identify one or more composite rule nodes using the rule graph associated with the template graph 300. For example, based on the atomic rule outcomes of the atomic rules represented by the atomic rule nodes 424 and 426 being true, the processing circuitry 104 may be configured to identify a composite rule node 434. The processing circuitry 104 may be further configured to associate the composite rule node 434 with the two executed atomic rule nodes 424 and 426 by way of edges. The composite rule node 434 may represent a composite rule that determines the order of the bird.

The LHS part of the composite rule represented by the composite rule node 434 may verify whether the feet of the bird is webbed and the bill of the bird is flat. Based on both conditions being satisfied, the LHS part of the composite rule represented by the composite rule node 434 may be evaluated to be true. Further, the RHS part of the composite rule represented by the composite rule node 434 may be executed. The RHS part of the composite rule represented by the composite rule node 434 may determine the order of the bird by evaluating the set of property values (for example, waterfowl and tubenose) associated with the order property represented by the property template node 326 and return the determined order of the bird. Based on the execution, the processing circuitry 104 may be configured to generate a composite rule outcome. In the ongoing discussion, as the bird has a webbed feet and a flat bill, the bird may be associated with the order ‘waterfowl’. That is to say, the composite rule outcome for composite rule represented by the composite rule node 434 may correspond to ‘waterfowl’. The processing circuitry 104 may be configured to generate a composite rule outcome node 436 to represent the composite rule outcome ‘waterfowl’. The processing circuitry 104 may be further configured to associate the composite rule outcome node 436 with the composite rule node 434 by way of an edge. The execution of the order rule may be based on another query associated with the real-time system 102.

Further, based on the atomic rule nodes 428 and 430 and the composite rule node 434, the processing circuitry 104 may be configured to identify another composite rule node 438 and associate the composite rule node 438 with the composite rule node 434 and the atomic rule nodes 428 and 430 by way of edges. The composite rule node 438 may represent a composite rule that determines the family of the bird. The composite rule represented by the composite rule node 438 may be executed in a similar manner as explained for the composite rule represented by the composite rule node 434. In the ongoing discussion, as the bird has a long neck, a white color, and is determined to be associated with the waterfowl order, the bird may be associated with the ‘swan’ family. Based on the execution, the processing circuitry 104 may be configured to generate a composite rule outcome representing ‘swan’. The processing circuitry 104 may be configured to generate a composite rule outcome node 440 to represent the composite rule outcome swan. The processing circuitry 104 may be further configured to associate the composite rule outcome node 440 with the composite rule node 438 by way of an edge. The execution of the family rule may be based on yet another query associated with the real-time system 102.

Similarly, the processing circuitry 104 may be configured to identify another composite rule node 442 based on the atomic rule outcomes for the atomic rule node 432 and the composite rule node 438 being true. The composite rule represented by the composite rule node 438 may determine the type of the bird. The processing circuitry 104 may be further configured to associate the composite rule node 442 with the composite rule node 438 and the executed atomic rule node 432 by way of edges. The composite rule represented by the composite rule node 442 may be executed in a similar manner as explained above. Based on the execution, the processing circuitry 104 may be configured to generate a composite rule outcome. In the ongoing discussion, as the bird has the whistle voice and is determined to be associated with the swan family, the bird may be a ‘whistling swan’. That is to say, the composite rule outcome for composite rule represented by the composite rule node 442 may correspond to a ‘whistling swan’. The processing circuitry 104 may be configured to generate a composite rule outcome node 444 to represent the composite rule outcome ‘whistling swan’. The processing circuitry 104 may be further configured to associate the composite rule outcome node 444 with the composite rule node 442 by way of an edge. The execution of the bird type rule may be based on yet another query associated with the real-time system 102.

The processing circuitry 104 may be configured to store the generated inference graph 400 in the storage circuitry 106. The inference graph 400 may allow the execution of the probe.

In an embodiment, a user associated with the real-time system 102 may submit a query into the real-time system 102 to justify why the bird represented by the data instance node 402 is associated with the swan family. In such a scenario, the processing circuitry 104 may receive the manual probe. To execute the manual probe, processing circuitry 104 may identify all the underlying rules (e.g., the atomic rules represented by the atomic rule nodes 428 and 430 and the composite rule represented by the composite rule node 434) associated with the composite rule represented by the composite rule node 438. Further, the processing circuitry 104 may determine if the input values required for the execution of these rules are present in the inference graph 400. If the required input values are present, the processing circuitry 104 may be configured to execute each of the underlying rules and generate the corresponding outcome. Based on the atomic rule outcomes and the composite rule outcome, the processing circuitry 104 may determine that the family of the bird represented by the data instance node 402 corresponds to the swan.

In some embodiments, based on a system change event associated with the real-time system 102, the processing circuitry 104 may receive an automated probe. For example, if the property value associated with the bird represented by the data instance node 402 is changed, the inference graph 400 may be re-evaluated based on an automated probe. For example, if the property value associated with the property value node 420 is changed to black, the automated probes may further determine the type of the bird based on the changed property value.

Thus, storing the inference graph 400 may allow efficient execution of the manual and automated probes, thereby, reducing computational cost and may further aid in efficient memory utilization.

In FIGS. 2A, 2B, 3A, 3B, and 4, the edges coupling various nodes are not numbered to keep the illustrations concise and clear, and should not be considered a limitation of the present disclosure.

Although not shown, the outcomes generated for each of the atomic rules and the composite rules (for example, the atomic rule outcomes ‘true’ or ‘false’) may be associated with the edges coupling each property instance node and the associated atomic rule nodes and the edges coupling the executed atomic rule nodes and the composite rule nodes. The outcomes may be associated as edge properties of these edges.

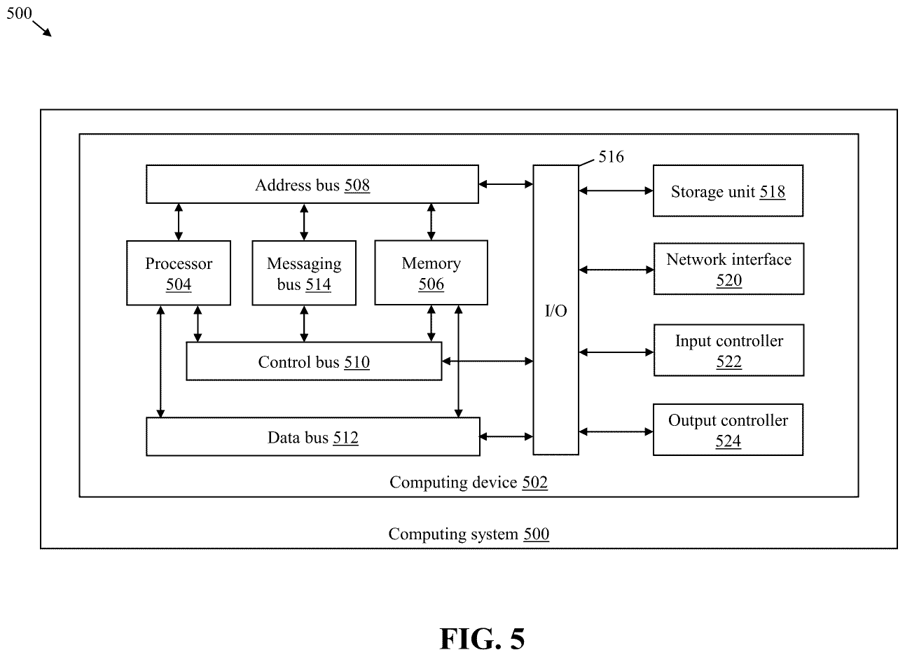

FIG. 5 illustrates an example computing system 500 for carrying out the methods of the present disclosure, consistent with disclosed embodiments of the present disclosure. Specifically, FIG. 5 shows a block diagram of an embodiment of the computing system 500 according to example embodiments of the present disclosure.

The computing system 500 may be configured to perform any of the operations disclosed herein. The computing system 500 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 500 is a distributed system configured to function using multiple computing machines interconnected via a data network or bus system.

The computing system 500 includes computing devices (such as a computing device 502). The computing device 502 includes one or more processors (such as a processor 504) and a memory 506. The processor 504 may be any general-purpose processor(s) configured to execute a set of instructions. For example, the processor 504 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 504 may be multiple processing units, a single processing core, multiple processing cores, special purpose processing cores, co-processors, or any combination thereof. The processor 504 may be communicatively coupled to the memory 506 via an address bus 508, a control bus 510, a data bus 512, and a messaging bus 514.

The memory 506 may include non-volatile memories such as a read-only memory (ROM), a programable read-only memory (PROM), an erasable programmable read-only memory (EPROM), a flash memory, or any other device capable of storing program instructions or data with or without applied power. The memory 506 may also include volatile memories, such as a random-access memory (RAM), a static random-access memory (SRAM), a dynamic random-access memory (DRAM), and a synchronous dynamic random-access memory (SDRAM). The memory 506 may include single or multiple memory modules. While the memory 506 is depicted as part of the computing device 502, a person skilled in the art will recognize that the memory 506 can be separate from the computing device 502.

The memory 506 may store information that can be accessed by the processor 504. For instance, the memory 506 (e.g., one or more non-transitory computer-readable storage mediums, memory devices) may include computer-readable instructions (not shown) that can be executed by the processor 504. The computer-readable instructions may be software written in any suitable programming language or may be implemented in hardware. Additionally, or alternatively, the computer-readable instructions may be executed in logically and/or virtually separate threads on the processor 504. For example, the memory 506 may store instructions (not shown) that when executed by the processor 504 cause the processor 504 to perform operations such as any of the operations and functions for which the computing system 500 is configured, as described herein. Additionally, or alternatively, the memory 506 may store data (not shown) that can be obtained, received, accessed, written, manipulated, created, and/or stored. The data can include, for instance, the data and/or information described herein in relation to FIGS. 1-4. In some implementations, the computing device 502 may obtain from and/or store data in one or more memory device(s) that are remote from the computing system 500.

The computing device 502 may further include an input/output (I/O) interface 516 communicatively coupled to the address bus 508, the control bus 510, and the data bus 512. The data bus 512 and messaging bus 514 may include a plurality of tunnels that may support parallel processing of messages. The I/O interface 516 is configured to couple to one or more external devices (e.g., to receive and send data from/to one or more external devices). Such external devices, along with the various internal devices, may also be known as peripheral devices. The I/O interface 516 may include both electrical and physical connections for operably coupling the various peripheral devices to the computing device 502. The I/O interface 516 may be configured to communicate data, addresses, and control signals between the peripheral devices and the computing device 502. The I/O interface 516 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, or the like. The I/O interface 516 is configured to implement only one interface or bus technology. Alternatively, the I/O interface 516 is configured to implement multiple interfaces or bus technologies. The I/O interface 516 may include one or more buffers for buffering transmissions between one or more external devices, internal devices, the computing device 502, or the processor 504. The I/O interface 516 may couple the computing device 502 to various input devices, including mice, touch screens, scanners, biometric readers, electronic digitizers, sensors, receivers, touchpads, trackballs, cameras, microphones, keyboards, any other pointing devices, or any combinations thereof. The I/O interface 516 may couple the computing device 502 to various output devices, including video displays, speakers, printers, projectors, tactile feedback devices, automation control, robotic components, actuators, motors, fans, solenoids, valves, pumps, transmitters, signal emitters, lights, and so forth.

The computing system 500 may further include a storage unit 518, a network interface 520, an input controller 522, and an output controller 524. The storage unit 518, the network interface 520, the input controller 522, and the output controller 524 are communicatively coupled to the central control unit (e.g., the memory 506, the address bus 508, the control bus 510, and the data bus 512) via the I/O interface 516. The network interface 520 communicatively couples the computing system 500 to one or more networks such as wide area networks (WAN), local area networks (LAN), intranets, the Internet, wireless access networks, wired networks, mobile networks, telephone networks, optical networks, or combinations thereof. The network interface 520 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 518 is a computer-readable medium, preferably a non-transitory computer-readable medium, comprising one or more programs, the one or more programs comprising instructions which when executed by the processor 504 cause the computing system 500 to perform the method steps of the present disclosure. Alternatively, the storage unit 518 is a transitory computer-readable medium. The storage unit 518 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 518 stores one or more operating systems, application programs, program modules, data, or any other information. The storage unit 518 is part of the computing device 502. Alternatively, the storage unit 518 is part of one or more other computing machines that are in communication with the computing device 502, such as servers, database servers, cloud storage, network attached storage, and so forth.

The input controller 522 may include suitable logic, circuitry, interfaces, and/or code, executable by the circuitry, that may be configured to control one or more input devices that may be configured to receive an input (e.g., a stimulus) generated by the real-time system 102. The output controller 524 may include suitable logic, circuitry, interfaces, and/or code, executable by the circuitry, that may be configured to control one or more output devices that may be configured to render/output the outcome of the operation executed to process the received input.

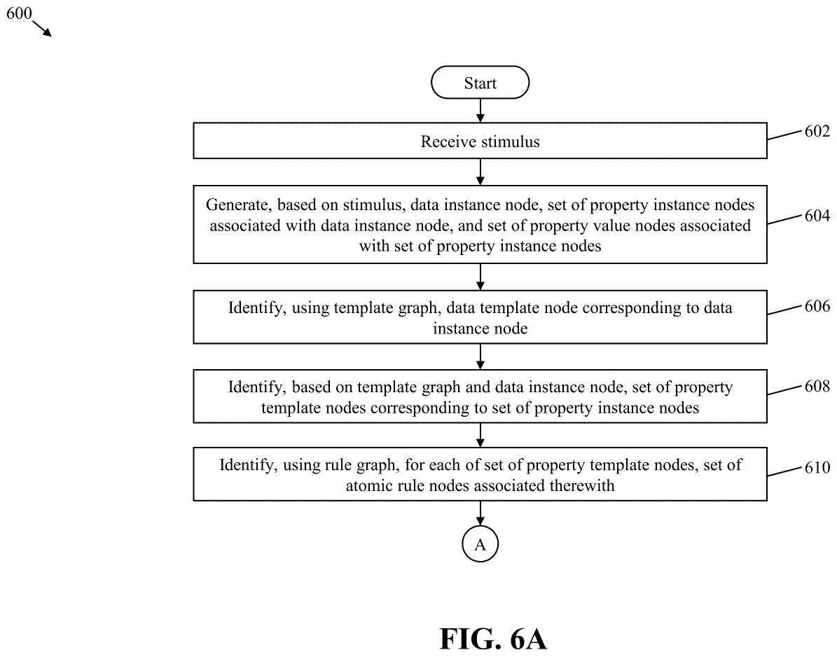

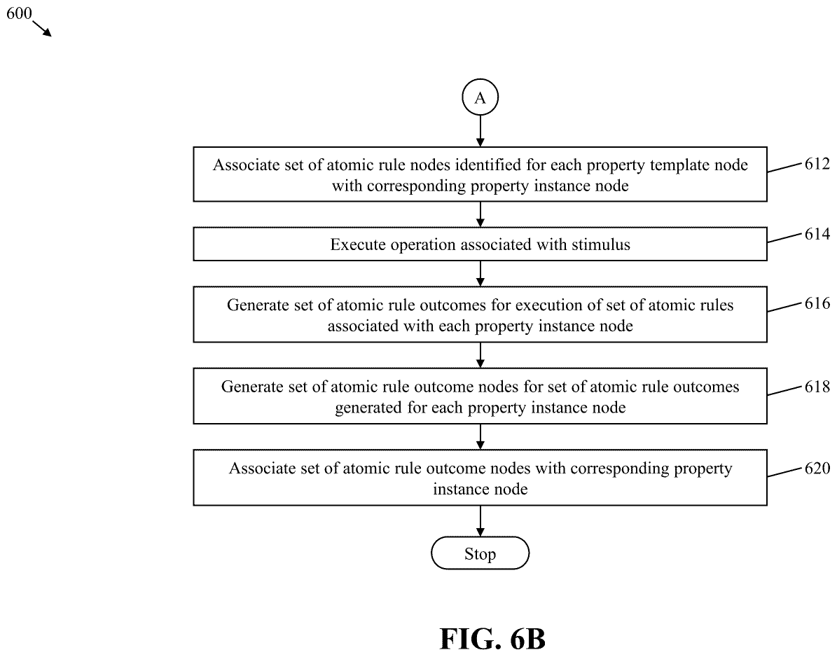

FIGS. 6A and 6B, collectively, represents a flowchart 600 that illustrates a method for facilitating inference engine using directed property graphs, consistent with disclosed embodiments of the present disclosure.

Referring to FIG. 6A, at 602, the processing circuitry 104 may receive a stimulus. At 604, the processing circuitry 104 may generate, based on the stimulus, a data instance node, a set of property instance nodes associated with the data instance node, and a set of property value nodes associated with the set of property instance nodes. For example, the processing circuitry 104 may generate, based on the stimulus, the data instance node 234, the property instance nodes 236 and 238, and the property value nodes 240 and 242. At 606, the processing circuitry 104 may identify, using a template graph, a data template node corresponding to the data instance node. For example, the processing circuitry 104 may identify the data template node 202. At 608, the processing circuitry 104 may identify, based on the template graph and the data instance node, a set of property template nodes corresponding to the set of property instance nodes. For example, the processing circuitry 104 may identify, based on the template graph 110 and the data instance node 234, the property template nodes 206 and 208 for the property instance nodes 236 and 238, respectively. At 610, the processing circuitry 104 may identify, using a rule graph, for each of the set of property template nodes, a set of atomic rule nodes associated therewith. For example, the processing circuitry 104 may utilize the rule graph 112 to identify the atomic rule nodes 218 and 220 associated with the property template node 206.

Referring to FIG. 6B, at 612, the processing circuitry 104 may associate the set of atomic rule nodes identified for each property template node with the corresponding property instance node. For example, the processing circuitry 104 may associate the atomic rule nodes 218 and 220 with the property instance node 236. At 614, the processing circuitry 104 may execute an operation associated with the stimulus. At 616, the processing circuitry 104 may generate a set of atomic rule outcomes for the execution of a set of atomic rules associated with each property instance node. For example, the set of atomic rule outcomes generated for the atomic rules represented by the atomic rule nodes 218 and 220. At 618, the processing circuitry 104 may generate a set of atomic rule outcome nodes for the set of atomic rule outcomes generated for each property instance node. For example, the processing circuitry 104 may generate the atomic rule outcome nodes 244 and 246 for the property instance node 236. At 620, the processing circuitry 104 may associate the set of atomic rule outcome nodes with the corresponding property instance node. For example, the processing circuitry 104 may associate the atomic rule outcome nodes 244 and 246 with the property instance node 236.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for an inference engine using directed property graphs. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:
1. A system, comprising:
   storage circuitry configured to store (i) a template graph that comprises a plurality of data template nodes and a plurality of property template nodes, and (ii) a rule graph that comprises a plurality of atomic rule nodes, where each data template node is associated with one or more property template nodes, and a property template node is associated with a set of atomic rule nodes; and
   processing circuitry that is coupled to the storage circuitry, and configured to:
      receive a stimulus;
      generate, based on the stimulus, (i) a data instance node, (ii) a set of property instance nodes associated with the data instance node, and (iii) a set of property value nodes associated with the set of property instance nodes;
      identify, based on the template graph and the data instance node, a set of property template nodes corresponding to the set of property instance nodes;
      identify, using the rule graph, for each of the set of property template nodes, the set of atomic rule nodes associated therewith; and
      execute an operation associated with the stimulus based on at least one of a group consisting of (i) the set of property instance nodes, (ii) the set of property value nodes, and (iii) the set of atomic rule nodes identified for each of the set of property template nodes.
2. The system of 1,
   wherein each data template node, of the plurality of data template nodes, represents an entity,
   wherein the one or more property template nodes, associated with each data template node, represent one or more properties associated with the entity, respectively, with a property having a set of property values, and
   wherein the set of atomic rule nodes, associated with the property template node, represents a set of atomic rules to be executed on the set of property values of the property represented by the corresponding property template node.
3. The system of 1, wherein the processing circuitry is further configured to identify, using the template graph, a data template node corresponding to the data instance node, and wherein the processing circuitry identifies the set of property template nodes from the one or more property template nodes associated with the identified data template node.
4. The system of 3,
   wherein each data template node, of the plurality of data template nodes, has an identifier associated therewith,
   wherein the data instance node has a template identifier associated therewith, and
   wherein the processing circuitry identifies, from the plurality of data template nodes, the data template node corresponding to the data instance node based on the identifier of the data template node matching the template identifier of the data instance node.
5. The system of 3, wherein the processing circuitry identifies the set of property template nodes from the one or more property template nodes based on the set of property value nodes.
6. The system of 1,
   wherein the template graph further comprises a plurality of property value nodes,
   wherein the property template node, of the one or more property template nodes, is further associated with one or more property value nodes, of the plurality of property value nodes, and
   wherein each of the identified set of property template nodes has at least one property value node that matches one of the set of property value nodes generated based on the stimulus.
7. The system of 6, wherein the one or more property value nodes, associated with the property template node, represent one or more property values of a property represented by the corresponding property template node.
8. The system of 1,
   wherein the set of atomic rule nodes represents a set of atomic rules,
   wherein the data instance node represents an entity,
   wherein the set of property instance nodes represents a set of properties of the entity,
   wherein the set of property value nodes represents a set of property values of the set of properties, and
   wherein to execute the operation, the processing circuitry is further configured to execute, for each property instance node of the set of property instance nodes, the set of atomic rules represented by the corresponding set of atomic rule nodes on a property value represented by the corresponding property value node.
9. The system of 8, wherein the processing circuitry is further configured to associate the set of atomic rule nodes identified for each property template node, of the set of property template nodes, with the corresponding property instance node, of the set of property instance nodes.
10. The system of 8,
   wherein the processing circuitry is further configured to generate a set of atomic rule outcomes for the execution of the set of atomic rules associated with each property instance node of the set of property instance nodes, and
   wherein an atomic rule outcome of the set of atomic rule outcomes corresponds to true or false.
11. The system of 10,
   wherein the processing circuitry is further configured to generate a set of atomic rule outcome nodes for the set of atomic rule outcomes generated for each property instance node of the set of property instance nodes, and associate the set of atomic rule outcome nodes with the corresponding property instance node, and
   wherein the data instance node, the set of property instance nodes, the set of property value nodes, an association of each property instance node with the corresponding set of atomic rule nodes, the set of atomic rule outcome nodes for each property instance node, and the association of each property instance node with the corresponding set of atomic rule outcome nodes constitute an inference graph.
12. The system of 11, wherein the processing circuitry is further configured to store the inference graph in the storage circuitry.
13. The system of 11, wherein the processing circuitry is further configured to: receive a probe; and
   generate a response to the probe based on the inference graph.
14. The system of 13, wherein the probe corresponds to at least one of a group consisting of (i) a manual probe or (ii) an automated probe generated based on a system change event.
15. The system of 11, wherein the inference graph corresponds to a directed property graph.
16. the System of 10,
   wherein the rule graph further comprises a plurality of composite rule nodes,
   wherein based on the set of atomic rule outcomes generated for each property instance node of the set of property instance nodes, the processing circuitry is further configured to identify, using the rule graph, one or more composite rule nodes,
   wherein each composite rule node, of the one or more composite rule nodes, is dependent on two or more executed atomic rule nodes, each having an atomic rule outcome that is true, and
   wherein the operation associated with the stimulus is further executed based on the one or more composite rule nodes.
17. The system of 16, wherein the processing circuitry is further configured to associate each of the one or more composite rule nodes with the corresponding two or more executed atomic rule nodes.
18. The system of 16,
   wherein the one or more composite rule nodes represent one or more composite rules, respectively, and
   wherein to execute the operation, the processing circuitry is further configured to execute the one or more composite rules based on two or more atomic rule outcomes of the dependent two or more executed atomic rule nodes, respectively.
19. The system of 16,
   wherein based on an execution of one or more composite rules, represented by the one or more composite rule nodes, respectively, the processing circuitry is further configured to identify, using the rule graph, at least one other composite rule node that is dependent on at least one of a group consisting of (i) one or more executed atomic rule nodes, each having an atomic rule outcome that is true, or (ii) one or more executed composite rule nodes, each having a composite rule outcome that is true, and
   wherein the operation associated with the stimulus is further executed based on the at least one other composite rule node.
20. The system of 16,
   wherein based on an execution of one or more composite rules, represented by the one or more composite rule nodes, the processing circuitry is further configured to generate one or more composite rule outcomes, respectively, and
   wherein the processing circuitry is further configured to generate one or more composite rule outcome nodes for the one or more composite rule outcomes, respectively.
21. The system of 20, wherein an association of the one or more composite rule nodes with the two or more executed atomic rule nodes, and the one or more composite rule outcome nodes generated for the one or more composite rule outcomes, respectively, constitute an inference graph.
22. The system of 20, wherein a composite rule outcome of the one or more composite rule outcomes corresponds to another property value associated with the data instance node.
23. The system of 1, wherein each of the template graph and the rule graph corresponds to a directed property graph.
24. A method, comprising:
   receiving, by processing circuitry of a system, a stimulus, wherein a template graph and a rule graph are stored in storage circuitry of the system, and wherein the template graph comprises a plurality of data template nodes and a plurality of property template nodes, and the rule graph comprises a plurality of atomic rule nodes, where each data template node is associated with one or more property template nodes, and a property template node is associated with a set of atomic rule nodes;
   generating, by the processing circuitry, based on the stimulus, (i) a data instance node, (ii) a set of property instance nodes associated with the data instance node, and (iii) a set of property value nodes associated with the set of property instance nodes;
   identifying, by the processing circuitry, based on the template graph and the data instance node, a set of property template nodes corresponding to the set of property instance nodes;
   identifying, by the processing circuitry, using the rule graph, for each of the set of property template nodes, the set of atomic rule nodes associated therewith; and
   executing, by the processing circuitry, an operation associated with the stimulus based on at least one of a group consisting of (i) the set of property instance nodes, (ii) the set of property value nodes, and (iii) the set of atomic rule nodes identified for each of the set of property template nodes.

What is claimed is:

1. A system, comprising:
storage circuitry configured to store (i) a template graph that comprises a plurality of data template nodes and a plurality of property template nodes, and (ii) a rule graph that comprises a plurality of atomic rule nodes, where each data template node is associated with one or more property template nodes, and a property template node is associated with a set of atomic rule nodes; and
processing circuitry that is coupled to the storage circuitry, and configured to:
receive a stimulus;
generate, based on the stimulus, (i) a data instance node, (ii) a set of property instance nodes associated with the data instance node, and (iii) a set of property value nodes associated with the set of property instance nodes;
identify, based on the template graph and the data instance node, a set of property template nodes corresponding to the set of property instance nodes;
identify, using the rule graph, for each of the set of property template nodes, the set of atomic rule nodes associated therewith; and
execute an operation associated with the stimulus based on at least one of a group consisting of (i) the set of property instance nodes, (ii) the set of property value nodes, and (iii) the set of atomic rule nodes identified for each of the set of property template nodes.

2. The system of claim 1,
wherein each data template node, of the plurality of data template nodes, represents an entity,
wherein the one or more property template nodes, associated with each data template node, represent one or more properties associated with the entity, respectively, with a property having a set of property values, and
wherein the set of atomic rule nodes, associated with the property template node, represents a set of atomic rules to be executed on the set of property values of the property represented by the corresponding property template node.

3. The system of claim 1,
wherein the processing circuitry is further configured to identify, using the template graph, a data template node corresponding to the data instance node, and
wherein the processing circuitry identifies the set of property template nodes from the one or more property template nodes associated with the identified data template node.

4. The system of claim 3,
wherein each data template node, of the plurality of data template nodes, has an identifier associated therewith,
wherein the data instance node has a template identifier associated therewith, and
wherein the processing circuitry identifies, from the plurality of data template nodes, the data template node corresponding to the data instance node based on the identifier of the data template node matching the template identifier of the data instance node.

5. The system of claim 3, wherein the processing circuitry identifies the set of property template nodes from the one or more property template nodes based on the set of property value nodes.

6. The system of claim 1,
wherein the template graph further comprises a plurality of property value nodes,
wherein the property template node, of the one or more property template nodes, is further associated with one or more property value nodes, of the plurality of property value nodes, and
wherein each of the identified set of property template nodes has at least one property value node that matches one of the set of property value nodes generated based on the stimulus.

7. The system of claim 6, wherein the one or more property value nodes, associated with the property template node, represent one or more property values of a property represented by the corresponding property template node.

8. The system of claim 1,
wherein the set of atomic rule nodes represents a set of atomic rules,
wherein the data instance node represents an entity,
wherein the set of property instance nodes represents a set of properties of the entity,
wherein the set of property value nodes represents a set of property values of the set of properties, and
wherein to execute the operation, the processing circuitry is further configured to execute, for each property instance node of the set of property instance nodes, the set of atomic rules represented by the corresponding set of atomic rule nodes on a property value represented by the corresponding property value node.

9. The system of claim 8,
wherein the processing circuitry is further configured to generate a set of atomic rule outcomes for the execution of the set of atomic rules associated with each property instance node of the set of property instance nodes, and
wherein an atomic rule outcome of the set of atomic rule outcomes corresponds to true or false.

10. The system of claim 9,
wherein the processing circuitry is further configured to generate a set of atomic rule outcome nodes for the set of atomic rule outcomes generated for each property instance node of the set of property instance nodes, and associate the set of atomic rule outcome nodes with the corresponding property instance node, and
wherein the data instance node, the set of property instance nodes, the set of property value nodes, an association of each property instance node with the corresponding set of atomic rule nodes, the set of atomic rule outcome nodes for each property instance node, and the association of each property instance node with the corresponding set of atomic rule outcome nodes constitute an inference graph.

11. The system of claim 10, wherein the processing circuitry is further configured to store the inference graph in the storage circuitry.

12. The system of claim 10, wherein the processing circuitry is further configured to:
receive a probe; and
generate a response to the probe based on the inference graph.

13. The system of claim 12, wherein the probe corresponds to at least one of a group consisting of (i) a manual probe or (ii) an automated probe generated based on a system change event.

14. The system of claim 10, wherein the inference graph corresponds to a directed property graph.

15. The system of claim 9,
wherein the rule graph further comprises a plurality of composite rule nodes,
wherein based on the set of atomic rule outcomes generated for each property instance node of the set of property instance nodes, the processing circuitry is further configured to identify, using the rule graph, one or more composite rule nodes,
wherein each composite rule node, of the one or more composite rule nodes, is dependent on two or more executed atomic rule nodes, each having an atomic rule outcome that is true, and
wherein the operation associated with the stimulus is further executed based on the one or more composite rule nodes.

16. The system of claim 15,
wherein the one or more composite rule nodes represent one or more composite rules, respectively, and
wherein to execute the operation, the processing circuitry is further configured to execute the one or more composite rules based on two or more atomic rule outcomes of the dependent two or more executed atomic rule nodes, respectively.

17. The system of claim 15,
wherein based on an execution of one or more composite rules, represented by the one or more composite rule nodes, respectively, the processing circuitry is further configured to identify, using the rule graph, at least one other composite rule node that is dependent on at least one of a group consisting of (i) one or more executed atomic rule nodes, each having an atomic rule outcome that is true, or (ii) one or more executed composite rule nodes, each having a composite rule outcome that is true, and
wherein the operation associated with the stimulus is further executed based on the at least one other composite rule node.

18. The system of claim 15,
wherein based on an execution of one or more composite rules, represented by the one or more composite rule nodes, the processing circuitry is further configured to generate one or more composite rule outcomes, respectively, and
wherein the processing circuitry is further configured to generate one or more composite rule outcome nodes for the one or more composite rule outcomes, respectively.

19. The system of claim 1, wherein each of the template graph and the rule graph corresponds to a directed property graph.

20. A method, comprising:
receiving, by processing circuitry of a system, a stimulus,
wherein a template graph and a rule graph are stored in storage circuitry of the system, and
wherein the template graph comprises a plurality of data template nodes and a plurality of property template nodes, and the rule graph comprises a plurality of atomic rule nodes, where each data template node is associated with one or more property template nodes, and a property template node is associated with a set of atomic rule nodes;
generating, by the processing circuitry, based on the stimulus, (i) a data instance node, (ii) a set of property instance nodes associated with the data instance node, and (iii) a set of property value nodes associated with the set of property instance nodes;
identifying, by the processing circuitry, based on the template graph and the data instance node, a set of property template nodes corresponding to the set of property instance nodes;
identifying, by the processing circuitry, using the rule graph, for each of the set of property template nodes, the set of atomic rule nodes associated therewith; and
executing, by the processing circuitry, an operation associated with the stimulus based on at least one of a group consisting of (i) the set of property instance nodes, (ii) the set of property value nodes, and (iii) the set of atomic rule nodes identified for each of the set of property template nodes.
